(19) United States
(12) Patent Application Publication
(10) Pub. No.: US 2026/0084583 A1
(43) Pub. Date: Mar. 26, 2026

(54) SYSTEM FOR REPLACING VEHICLE BATTERY MODULES AND METHOD THEREOF

(71) Applicants: CPS Technology Holdings LLC, New York, NY (US); Clarios Germany GmbH & Co. KG, Hannover (DE)

(72) Inventors: John P. Bania, Whitefish Bay, WI (US); Zhihong Jin, Pewaukee, WI (US); Wei Song, Milwaukee, WI (US); Markus Hoh, Wunstorf (DE); Deepan C. Bose, Milwaukee, WI (US); Jason D. Searl, Bayside, WI (US); Craig W. Rigby; Cagatay Topcu, Milwaukee, WI (US)

(21) Appl. No.: 19/130,950

(22) PCT Filed: Nov. 17, 2023
(86) PCT No.: PCT/US2023/080321

§ 371 Date: May 18, 2025

Related U.S. Application Data
(60) Provisional application No. 63/426,611, filed on Nov. 18, 2022.
(60) Provisional application No. 63/509,643, filed on Jun. 22, 2023.

(51) Int. Cl. B60L 58/16; H01M 10/48; H01M 50/209; H01M 50/249

(52) U.S. Cl. CPC B60L 58/16; H01M 10/482; H01M 50/209; H01M 50/249; B60L 2240/662; H01M 2220/20

(57) ABSTRACT

A system and method for determination of and communicating replacement determinations and maintenance scheduling for battery modules is disclosed. The method includes calculating a life estimation for the battery module based on received information and collected data, the battery module may be in communication with a server remote from the battery module, with the server having a value for enterprise acceptability for the battery module, the server may comprise a communication module to receive the information from the battery module, a processor; and memory operatively connected to the processor, with the processor executing the instructions for calculating a life estimation for the battery module based on the received information and the collected data, further the system may provide a for a predictive maintenance program.

### RELATED APPLICATIONS

This application claims the benefit of the following provisional applications, each of which is incorporated herein by reference in their entireties: U.S. Application No. 63/426,611, filed on Nov. 18, 2022; U.S. Application No. 63/509,643, filed on Jun. 22, 2023.

### BACKGROUND

The disclosure relates to life estimations for batteries and battery modules, such as lithium-ion battery modules, lead acid batteries, and battery modules with different chemistries, and improvement of the life estimation or theoretical end life for a battery module for replacement and/or exchange with a fleet of batteries. The disclosure also relates to systems and methods for calculation of and communicating replacement determinations for a battery module. The disclosure further applies historical battery data to systems and methods for calculation of communicating replacement determinations for a battery module.

Battery modules may be used in vehicular contexts as well as other energy storage and expending applications (e.g., an energy storage for an electrical grid). That is, the battery modules described herein may be used to provide power to various types of vehicles. However, it is envisioned that the battery modules may be used in other energy storage and expending applications. As an example, battery modules in accordance with herein may be incorporated with or provide power to stationary power systems.

An electrical system may include one or more battery modules. A battery module has a housing and a number of battery cells (e.g., lithium-ion electrochemical cells) arranged within the housing to provide particular voltages and/or currents useful to power one or more electrical components, devices, or systems. For ease of description, the disclosure herein will primarily focus on vehicles having a battery module. The battery systems described herein may be used to provide power to various types of vehicles.

The battery systems described herein may also be used to provide power to other energy storage/expending applications. Other example applications or environments include: starting, cycling, and powernet support applications; deep cycle primary power and motive power applications; and high rate and long duration reserve power applications. Example starting, cycling, and powernet support applications include: automotive; van and light duty commercial; heavy duty truck; bus and utility; agriculture; construction; marine; residential vehicle (RV); power sports including motorcycle, all-terrain vehicle (ATV), snowmobile, electric bicycle; genset; lawn and garden; rail; military, aerospace, and defense; etc. Example deep cycle primary power and motive power applications include: heavy duty load and lift gates; marine cycling; golf vehicles; motive such as forklift and guided vehicles; industrial such as scissor lift, scrubber, and pallet jack; wheelchairs; etc. Example high rate and long duration reserve power applications include: uninterruptable power source such as for a data center, critical power system, and emergency lighting; telecommunications such as wireline, wireless, broadband, and microwave; power generation and distribution, renewable energy; grid support including smart and distributed; safety, security, and traffic; etc. Such battery systems may include one or more batteries, each battery having a housing and a number of battery cells arranged within the housing, to provide particular voltages, currents, and/or power to the associated application.

A vehicle (e.g., an electric vehicle, a petrol or gasoline vehicle, a hybrid vehicle) uses one or more batteries or battery modules (collectively referred to herein as battery modules). In one example, a vehicle may have a plurality of battery modules, which may include a first battery module having a first battery chemistry and a second battery module having a second, different battery chemistry or the same battery chemistry. For example, the first battery module can be a lead-acid battery module (or battery), and the second battery module may be a lithium-ion (Li-ion) battery module (or battery). Different battery module arrangements for a vehicle are well within the knowledge of a person of ordinary skill in the art.

The performance requirements of batteries (e.g., from a standard lead-acid battery) have changed with evolving vehicle technologies. For example, many recent vehicles are equipped with “start/stop technology,” which aims to reduce fuel consumption and idle emissions. Typically, a vehicle will continue to provide internal functions (air conditioning/heat, radio, etc.) while the engine is turned off during a start/stop event. Then, when the vehicle is no longer at rest/stopped, the engine is restarted. Starting the engine creates a draw on the battery, as does maintaining vehicle functionality while the engine is off. A function of batteries is to facilitate the start/stop events and to support subsequent load. As battery performance decreases, engines will fail to execute start/stop events. As start/stop events fail, the engine continues to run, continually using fuel and outputting idle emissions resulting in increased fuel consumption and idle emissions over an engine coupled to a battery without decreased performance.

Consumers may have minimal understanding of battery health. A consumer may not understand why she/he should replace a battery. Coupled to that, vehicles are demanding more from the battery including increased performance requirements on the battery. Newer battery technologies have been developed for these more demanding vehicle electrical needs. In certain technologies, a battery management system (BMS) may be intelligent enough to know when the performance of the battery is degrading and will therefore change how the battery is being used. As the battery degrades over time, the BMS in the vehicle may decide to not turn off the engine as often. In such a case, the battery module has not technically failed producing a no-start condition, but it has reduced performance. Further, batteries lose efficiency after various periods and/or conditions of use. Moreover, some batteries contain manufacturing defects that negatively affect the productivity of the battery. Accordingly, it is desirable to better monitor a status of a battery or battery module after manufacture.

### SUMMARY

Disclosed herein are systems and methods for determination of and communicating replacement determinations and maintenance scheduling for battery modules. The systems and methods include calculating a life estimation, attainment of a value for enterprise acceptability for the battery module, in doing so a battery state marker is calculated, and calculating a maintenance schedule for the battery module, based on received information and collected data. Such may also be performed for a grouping or fleet of battery modules. The battery module may be in communication with a server remote from the battery module, with the server calculating the life estimation, attaining the value for enterprise acceptability for the battery module, in calculating the battery state marker, and calculating the maintenance schedule. In some embodiments, the system may be applied for batteries with intelligence and/or without such. The system may be integrated with an ECU of a vehicle or system housing the battery module.

In an embodiment, a battery replacement system based on a value for enterprise acceptability of a battery module comprises the following. A sensor to sense a parameter of the battery module. A processor and memory operatively coupled to the sensor, the memory including instructions executable by the processor to maintain battery module information, store the sensed parameter, and communicate the battery module information and the sensed parameter. A server in communication with the battery module for receipt of the battery module information and the sensed parameter, and one of the battery module and the server having a calculation for a life estimation and a replacement determination for the battery module based on a value for enterprise acceptability.

A method applying the aspect comprises: receiving information from a battery module; calculating a life estimation for the battery module based upon the received information; determining a value for enterprise acceptability for the battery module based upon the received information; and communicating a replacement determination based on a comparison based upon of the life estimation and the value for enterprise acceptability.

In another aspect of the embodiment, a battery replacement system based upon a value for enterprise acceptability of a battery module comprises the following. A battery module comprising: a housing; one or more battery cells arranged within the housing; a sensor to sense a parameter of the battery module; and a processor and a memory operatively connected to the sensor. The memory includes instructions executable by the processor to: acquired data related to the sensed parameter; retain battery module information; and communicate the battery module information and at least a portion of the sensed data. A server in communication with the battery module for receipt of the information. One of the battery module and the server calculates a life estimation for the battery module based on the information and makes a replacement determination based on comparing the life estimation with the value for enterprise acceptability.

A method applying the aspect comprises: receiving information from a battery module; collecting data from the received information, the collected data functionally related to end of life determinations; calculating a life estimation for the battery module based on the received information and the collected data; determining a value for enterprise acceptability for the battery module; comparing the life estimation with the value for enterprise acceptability for the battery module; and communicating a replacement determination based on the comparison.

In another aspect of the embodiment a system for communicating replacement determinations for a vehicle battery module comprises the following. The battery module having a sensor for a first receipt of battery data. The sensor communicatively coupled to a remote computational device for a transfer of the battery data. The remote computational device having: an analysis of the battery data for a calculation of a battery health; and a computation of a battery state marker and a battery maintenance based upon the battery health.

A method applying the aspect comprises: acquiring battery module parameters for a battery module and calculating a first data applying the battery module parameters; determining a second data with a vehicle and environmental data; communicating the first data and the second data to an external system; and labeling the battery module with a health indicator according to a computation of a health of the battery module; and computing a maintenance schedule for the battery module.

A system for communicating replacement determinations for a vehicle battery module, comprises the following. The battery module having a sensor; a battery data of the battery module retrievable with the sensor. The sensor in communication with a remote computational device for a transfer of the battery data. The remote computational device having a battery health analyzer for analysis of: a battery health of the battery module; a battery state marker based upon the battery health; and a computed maintenance schedule for the battery module. The remote computational device electrically coupled to a second remote device for a display of one or more of the battery health, the battery state marker, and the computed maintenance schedule.

A method applying the aspect comprises: sensing and acquiring battery module parameters; calculating a first data from the battery module parameters retrieved from the battery module; collecting vehicle and environmental data; determining a second data with the vehicle and environmental data; communicating the first data and the second data to an external system; computing a health of the battery module with the first data and the second data; labeling the battery module with a health indicator according to the computed health of the battery module; computing a maintenance schedule for the battery module; and communicating the health indicator and the maintenance schedule to a mobile device.

Also disclosed is a server. The server comprises a communication module to receive the information from the battery module. The server includes a processor and memory operatively connected to the processor. The memory stores instructions that, when executed by the processor, cause the processor to receive the information, and collect data from the received information. The collected data functionally relates to life estimations. The processor, when executing the instructions, calculates a life estimation for the battery based on the received information and the collected data, determine a value for enterprise acceptability for the battery, compare the life estimation with the value for enterprise acceptability for the battery, and communicate a replacement determination based on the comparison.

Improving the life estimation or theoretical end life for a battery module for replacement and/or exchange with a fleet of batteries provides advantages for operators or owners of vehicles with the battery modules. These and other features, advantages, and embodiments of apparatus, systems, and methods according to this invention are described herein, or are apparent from, the following detailed descriptions of the various examples of embodiments.

### BRIEF DESCRIPTION OF THE DRAWINGS

Various examples of embodiments of the apparatus, systems, and methods according to this invention will be described in detail with reference to the following figures.

FIG. 1 is a perspective view of a vehicle having a battery system contributing all or a portion of the power for the vehicle, illustrating a first aspect of a battery monitoring system.

FIG. 2 is a cutaway schematic view of the vehicle of FIG. 1, in the form of a hybrid electric vehicle (HEV) having a battery module.

FIG. 3 is a perspective view of a lead-acid battery that can be used in the vehicle of FIG. 1.

FIG. 4 is a perspective view of the lead-acid battery of FIG. 3 with the cover removed.

FIG. 5 is a partially-exploded perspective view of the lead-acid battery of FIG. 3.

FIG. 6 is a perspective view of a first aspect of a battery module, a lithium-ion battery module, that can be used in the vehicle of FIG. 1.

FIG. 7 is a partially-exploded perspective view of the li-ion battery module of FIG. 6, illustrating a second aspect of the battery monitoring system.

FIG. 8A is a block diagram of a second aspect of the battery module, illustrating a third aspect of the battery monitoring system.

FIG. 8B is a schematic view of a battery cell that may be employed within the battery module of FIG. 8A, having a measurement device.

FIG. 8C is a block diagram of the third aspect of the battery monitoring system.

FIG. 9A is a perspective view of a third aspect of the battery module.

FIG. 9B is a perspective view of a third aspect of the battery module with a cover removed, illustrating a fourth aspect of the battery monitoring system.

FIG. 9C is a perspective view of a fourth aspect of the battery module.

FIG. 9D is a perspective view of a fourth aspect of the battery module with a cover removed, illustrating a fourth aspect of the battery monitoring system.

FIG. 9E is a block diagram of the third and fourth aspects of the battery module, illustrating a fourth aspect of the battery monitoring system.

FIG. 10 is a block diagram representing a battery replacement system.

FIG. 11 is a block diagram representing a portion of an electronic device or mobile electronic device used in the system of FIG. 11.

FIG. 12 is a block diagram representing a portion of a server used in the system of FIG. 11.

FIG. 13 is a block diagram representing a first aspect of a method of operation of the battery replacement system.

FIG. 14 is a block diagram representing a second aspect of the embodiment of the battery replacement system.

FIG. 15 is a block diagram of a second aspect of the method of applying the second aspect of the battery replacement system.

FIG. 16 is a process of applying the second aspect of the embodiment of the battery replacement system.

FIG. 17A is a tiered block diagram of the second aspect of the battery replacement system, illustrating groupings of components of the battery monitoring system.

FIG. 17B is a tiered block diagram of the second aspect of the method as applied to the second aspect of the battery replacement system, illustrating functionalities of the groupings of components of the battery monitoring system.

FIG. 18 is a block diagram of a relationship of the components of the battery monitoring system and the battery replacement system.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

Within the scope of this application, it is expressly intended that various aspects, embodiments, examples and alternatives set out in the preceding paragraphs, and the claims and/or the following description and drawings, and in particular the individual features thereof, may be taken independently or in combination. That is, all embodiments and all features of any embodiment (e.g. embodiments designated with anyone one of the following identifying numbering suffixes “A”, “B”, “C”, “D”, “E”, “F”) can be combined in any way and/or combination, unless such features are incompatible. The applicant reserves the right to change and originally filed claim or file any new claim accordingly, including the right to amend any originally filed claim to depend from and/or incorporate any feature of any other claim although not originally claimed in that manner.

### DETAILED DESCRIPTION

The battery modules described herein may be used to provide power to various types of vehicles and other energy storage/expending applications (e.g., electrical grid power storage systems). Such battery systems may include one or more battery modules, each battery module having a housing and a number of battery cells arranged within the housing to provide particular voltages and/or currents useful to power, for example, one or more components of a vehicle. As another example, battery modules in accordance with present may be incorporated with or provide power to non-vehicle applications, such as stationary power systems connected to or separate from a utility power grid. For ease of explanation, the below description of an energy storage/expending application and battery life determination system will focus on a hybrid-electric vehicle. One skilled in the art of battery technologies will be able to extend the invention(s) and aspects of the invention(s) herein to other energy storage/expending applications, including other stationary and nonstationary contexts.

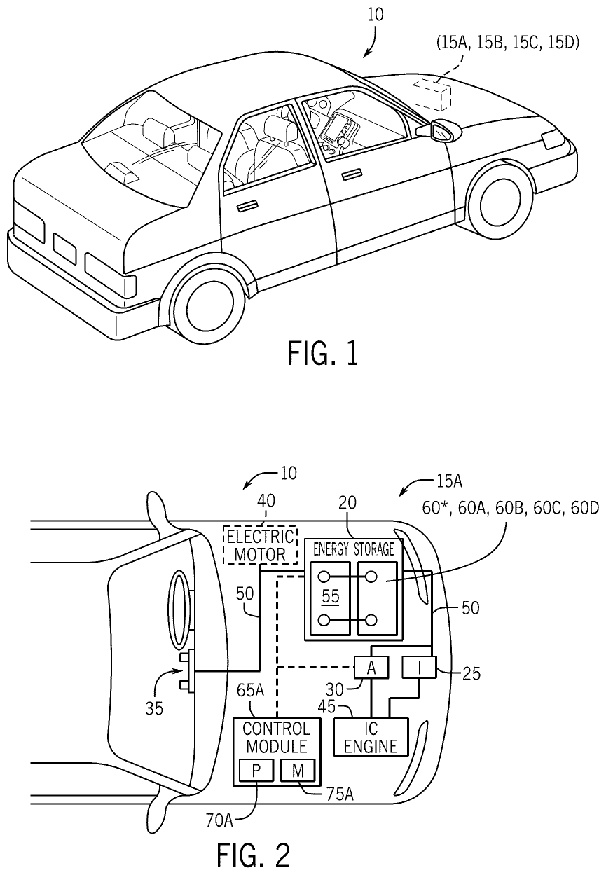

With reference to FIGS. 1 and 2, a vehicle 10, having a battery system 15A, which may utilize a regenerative braking system is illustrated. As depicted, the battery system 15A includes an energy storage component 20. The energy storage component is coupled to an ignition system 25, an alternator 30, a vehicle console 35, and optionally to an electric motor 40. Generally, the energy storage component 20 may capture/store electrical energy generated in the vehicle 10 and output electrical energy to power electrical devices in the vehicle 10.

The battery system 15A may supply power to components of the vehicle's electrical system, which may include radiator cooling fans, climate control systems, electric power steering systems, active suspension systems, auto park systems, electric oil pumps, electric super/turbochargers, electric water pumps, heated windscreen/defrosters, window lift motors, vanity lights, tire pressure monitoring systems, sunroof motor controls, power seats, alarm systems, infotainment systems, navigation features, lane departure warning systems, electric parking brakes, external lights, any combination thereof, etc. In the depicted construction, the energy storage component 20 supplies power to the vehicle console 20 and the ignition system 25, which may be used to start (e.g., crank) the internal combustion engine 45, and the electric motor 40.

Additionally, the energy storage component 20 may capture electrical energy generated by the alternator 30 and/or the electric motor 40 when acting in a generation state. In some implementations, the alternator 30 generates electrical energy while the internal combustion engine 45 is running. Additionally or alternatively, when the vehicle 10 includes an electric motor 40, the electric motor 40 can generate electrical energy by converting mechanical energy produced by the movement of the vehicle 10 (e.g., rotation of the wheels) into electrical energy. Thus, the energy storage component 20 may capture electrical energy generated by the electric motor 40 during regenerative braking.

To facilitate capturing and supplying electric energy, the energy storage component 20 may be electrically coupled to the vehicle's electric system via a bus 50. For example, the bus 50 enables the energy storage component 20 to receive electrical energy generated by the alternator 30 and/or the electric motor 40. Additionally, the bus 50 may enable the energy storage component 20 to output electrical energy to the ignition system 25 and/or the vehicle console 35.

Additionally, as depicted, the energy storage component 20 includes multiple battery modules. For example, in the depicted embodiment, the energy storage component 20 includes a lithium-ion (Li-ion) (e.g., a first) battery module 55 and a lead-acid (e.g., a second) battery module 60. In other constructions, the energy storage component 20 includes any number of battery modules (55 and/or 60). Additionally, although the lithium-ion battery module 55 and lead-acid battery module 60 are depicted adjacent to one another, they may be positioned in different areas around the vehicle.

In some implementations, the energy storage component 20 includes multiple battery modules to utilize multiple different battery chemistries, battery voltages, and/or battery current capabilities. For example, when the lithium-ion battery module 55 is used, performance of the battery system 15A may be improved since the lithium-ion battery chemistry generally has a higher coulombic efficiency and/or a higher power charge acceptance rate (e.g., higher maximum charge current or charge voltage) than the lead-acid battery chemistry. As such, the capture, storage, and/or distribution efficiency of the battery system 15A may be improved.

To facilitate controlling the storing and controlling of electrical energy, the battery system 15A further includes a control module 65A. More specifically, the control module 65A may control operations of components in the battery system 15A, such as relays (e.g., switches) within the energy storage component 20, the battery module (55 and/or 60), the alternator 30, and/or the electric motor 40. The control module 65A may regulate the amount of electrical energy stored/supplied by each battery module (55 and/or 60) (e.g., to de-rate and re-rate the battery system 15A), perform load balancing between the battery modules (55 and/or 60), determine a state of charge of each battery module (55 and/or 60), determine temperature of each battery module (55 and/or 60), control voltage output by the alternator 30 and/or the electric motor 40, and the like. The control module 65A may be part of a vehicle control module (VCM) and/or a battery control module (BCM). As illustrated in FIG. 2, the control module 65A includes one or more processors 70A and one or more memories 75A. Exemplary processors and memories will be discussed in further detail below. Furthermore, as depicted, the lithium-ion battery module 55 and the lead-acid battery module 60 are connected in parallel across their terminals. In other words, the lithium-ion battery module 55 and the lead-acid battery module 60 may be coupled in parallel to the vehicle's electrical system via the bus 50. However, other arrangements are envisioned.

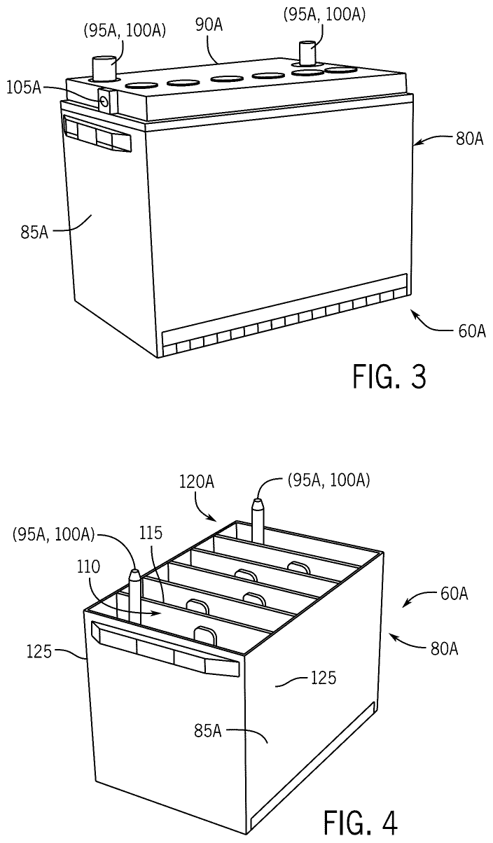

With reference to FIGS. 3-5, an example lead-acid battery 60A is illustrated. The lead-acid battery 60A has a battery housing 80A. The shown lead-acid battery 60 is used for understanding the apparatus (or system) and process (or method) described herein. As illustrated in FIG. 3, the battery housing 80A includes a housing base 85A and a cover 90A. The cover 90A is secured to the housing base 85A (e.g., by heat sealing the cover to the battery at various points or other mechanical means). The battery further includes terminals (95A, 100A), or bushings, protruding through or on the housing (e.g., the cover 90A as shown). The terminals (95A, 100A) are provided on the cover for connecting or coupling the battery to electrical loads. The battery additionally includes a vent aperture 105A for venting gas from a venting system, positioned on either or both of the housing base 85A and the cover 90A.

With reference to FIG. 4, the battery housing 80A is illustrated with the cover 90A removed. The battery housing 80A supports a plurality of battery cell compartments (one compartment 110 is labelled). The cell compartments 110 may be formed by a structural relationship (whether molded or structural linked) between the battery housing 80A, specifically the housing base 85A, and a plurality of cell walls or partitions (one wall or partition 115 is labelled) that define the plurality of cell compartments (one cell compartment 110 is labelled) within a housing cavity 120A defined by the interconnection between housing base 85A and the cover 90A. The walls or partitions 115 are formed with the housing cavity 120A and at least one wall or partition 115 may extend between opposing sides 125 of the housing base 85A. The walls or partitions 115 may be formed as being in unitary one-piece construction with the battery housing 80A, specifically the housing base 85A. While the construction of the housing base 85A, cover 90A and walls or partitions 115 discussed herein provides for six cell compartments 110 within the cavity 120A, a different number of cell compartments 110 may be provided within the cavity 120A. Further, while the shown cell compartments 110 are generally rectangular shape, other shapes may be used for the compartments (e.g., cylindrical).

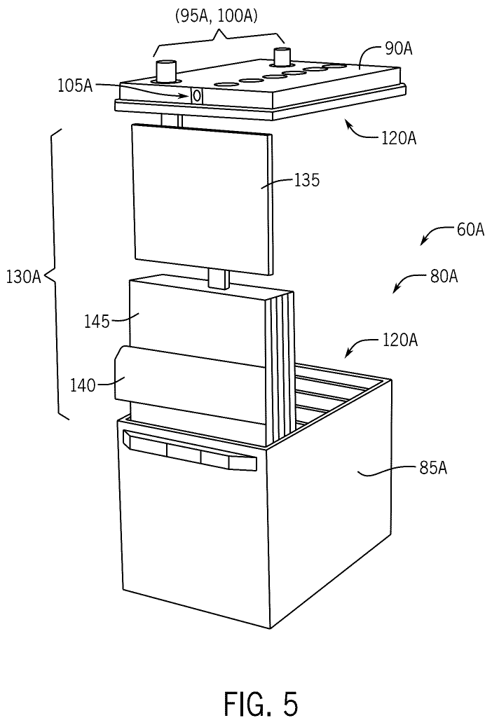

With reference to FIG. 5, the battery 60 is illustrated in an exploded view, with one of a plurality of battery cells 130A being illustrated in a partially exploded view. The battery cell 130A of the battery 60 includes a plurality of positive frames or plates 135, a plurality of separators 140 at least partially surrounding the positive frames or plates 135, and a plurality of negative frames or plates 145. For clarity of reading, Applicant shall reference the positive frames or plates 135 as the positive frame(s) 135 in its singular or plural form. For clarity of reading, Applicant shall reference the negative frames or plates 145 as the negative frame(s) 145 in its singular or plural form. The battery cell 130A of the battery 60 comprises at least one of the following combination, one positive frame 135, one separator 140, and one negative frame 145 in laminar or layered communication.

In a lead-acid battery, the positive and negative electrode frames (135, 145) of the battery cell 130A each comprise a lead or lead-alloy grid that serves as a substrate and supports an electrochemically active material deposited or otherwise provided thereon during manufacture to form the battery frames (135, 145). The grids of the positive and negative electrode frames (135, 145) provide an electrical contact between the positive and negative active materials or paste which serves to conduct current within and beyond the battery 60. Positive and negative electrode frames (135, 145) can be classified into various types according to the method of manufacturing, e.g. punched or cast.

Separators 140 can be provided between the frames (135, 145) to prevent shorting and/or undesirable electron flow produced during the reaction occurring in the battery 60.

Specifically, at least one separator 140 is placed between a positive frame 135 and a negative frame 145 adjacent to one another. The one or more battery separators 140 are used to conductively separate the positive and negative electrode frames (135, 145). The separator material of the separator 140 may have sufficient porosity and retention to contain at least substantially all of an electrolyte contained in the battery 60 and necessary to support the electrochemical reactions within the battery 60. In doing so, a minimal amount of electrolyte may be free flowing, or pooled, or suspended in the cavity 120A of the battery 60 that is outside of the separator(s) 140.

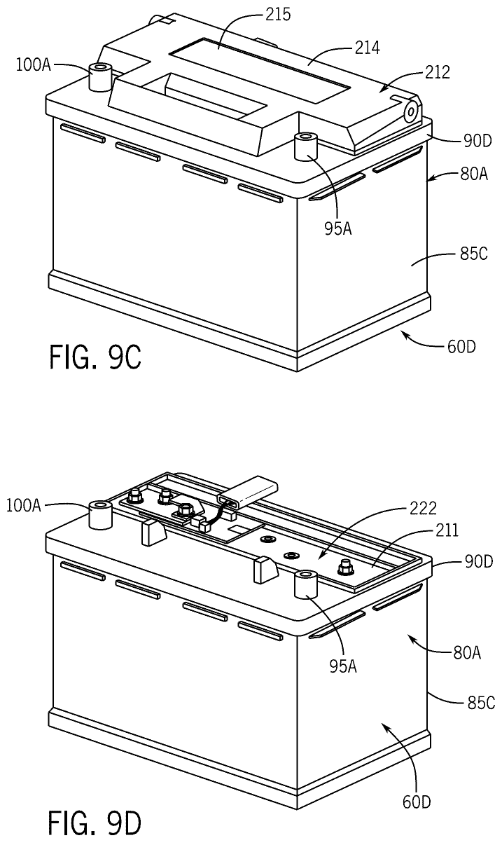

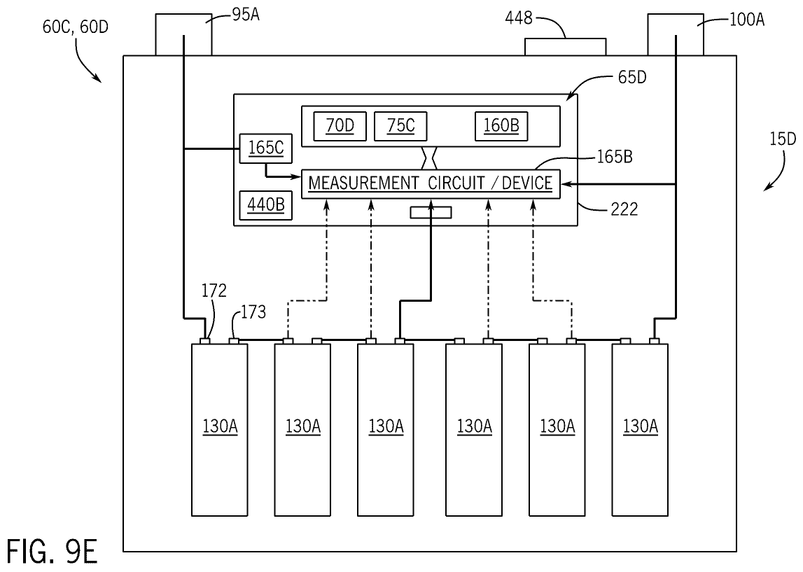

The lead-acid battery 60 discussed thus far in FIGS. 3-5 is an example type of a lead-acid battery known in the art. A person of ordinary skill in the battery art would understand that other lead-acid battery types, designs, and/or arrangements can be used in alterative to the lead-acid battery 60 shown in FIGS. 3-5. Also as will become more apparent below, the lead-acid battery 60 can include a battery control module (BCM) (65A, 65C, and 65D) as part of or distinct from the lead-acid battery 60, FIGS. 9A to 9E.

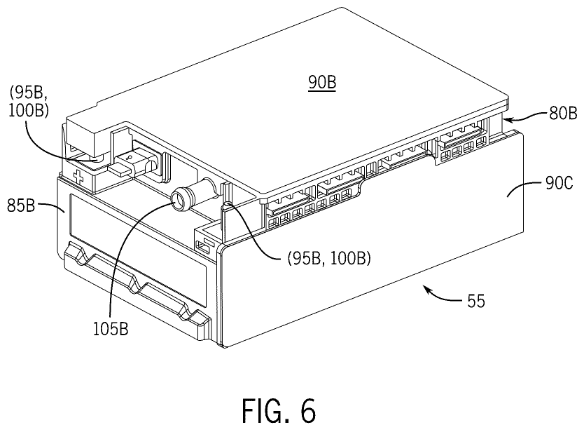

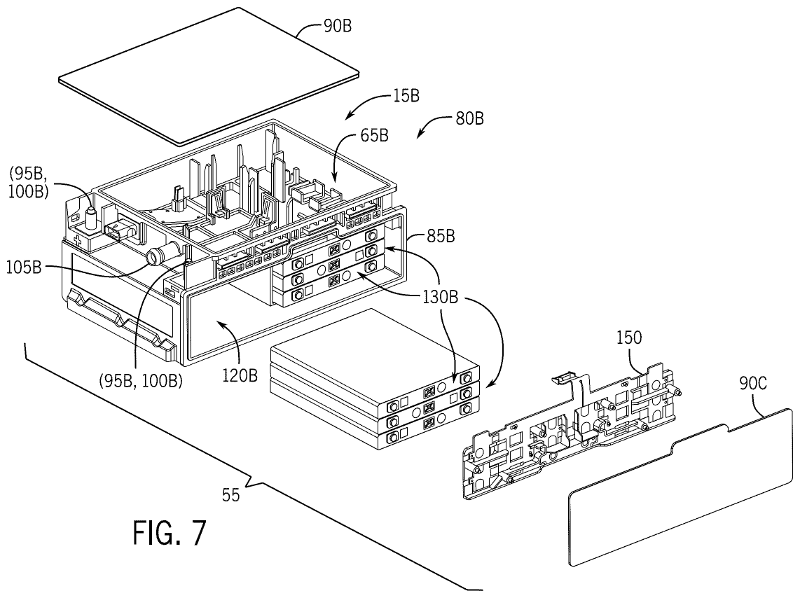

With reference to FIGS. 6 and 7, an example of a first aspect of the battery module, a lithium-ion (Li-ion) battery module, 55 that can also be used in a vehicle 10 is illustrated. The illustrated li-ion battery module 55 is an example and used for understanding the apparatuses and processes described herein.

As illustrated in FIGS. 6 and 7, the Li-ion battery module, 55 includes a Li-battery housing 80B which may likewise comprise a base 85B and a number of covers (90B, 90C). The covers (90B, 90C) are secured to the base 85B (e.g., by heat sealing the cover to the battery at various points or other mechanical means). The battery further includes terminals (95B, 100B), or bushings, protruding through or positioned on the housing 80B for connection of the battery to the external environment, and a vent aperture 105B for venting gas from a venting system. The terminals (95B, 100B) are provided on the cover for connecting or coupling the battery to electrical loads (e.g., a vehicle electrical system). It is observed the terminals 95A and 95B provide for the same properties, and for convenience of the reader Applicant shall apply 95A throughout the remainder of this application for reference to either or both of terminals 95A and terminals 95B. It is observed terminals 100A and 100B provide for the same properties, and for convenience of the reader Applicant shall apply 100A throughout the remainder of this application for reference to both or either terminals 100A or terminals 100B.

With reference to FIG. 7, a partially exploded view of the Li-ion battery module 55 is illustrated. Li-ion cells (one cell 130B is labelled) are provided in a Li-housing cavity 120B of the Li-ion battery module 55 defined by the housing 80B. An electrical conduction assembly (or printed circuit board (PCB) assembly) 150 may likewise be provided, whether within or external to the cavity 120B of the housing 80B and is electrically coupled to the Li-ion cells 130B. The electrical conduction assembly 150 may couple the Li-ion cells 130B to a Li-ion battery control system, second aspect of the battery monitoring system, 15B which comprises a Li-ion battery control module (BCM) 65B, with the BCM 65B being positioned within or external to the cavity 120B of the housing 80B. The electrical conduction assembly 150 may be considered part of the BCM 65B or separate from the BCM 65B. The BCM 65B monitors the Li-ion cells 130B and controls current between the Li-ion cells 130B and the terminals (95B, 100B). The BCM 65B may include additional control circuitry and operation as known in the art. In doing so, the battery monitoring system 15B and Li-ion battery control module (BCM) 65B monitor the health of the battery 55 and battery cells 130B.

The Li-ion battery module 55 discussed in FIGS. 6 and 7 is an example type of a Li-ion battery module known in the art. A person of ordinary skill in the battery art would understand that other non-lithium-ion battery types, designs, and/or arrangements can be used in alterative to the Li-ion battery module 55 shown in FIGS. 6 and 7.

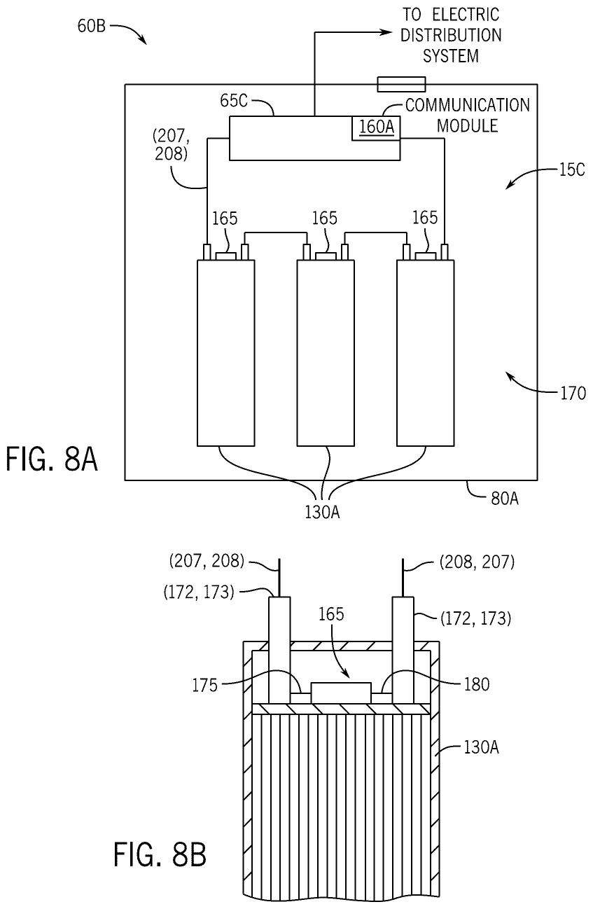

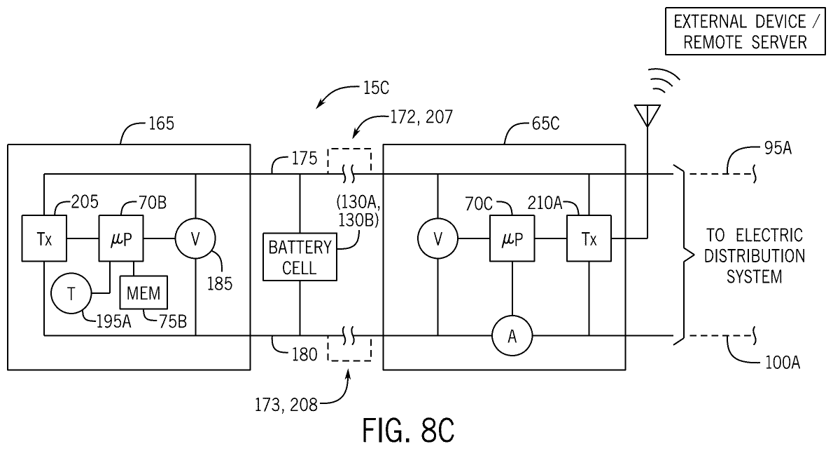

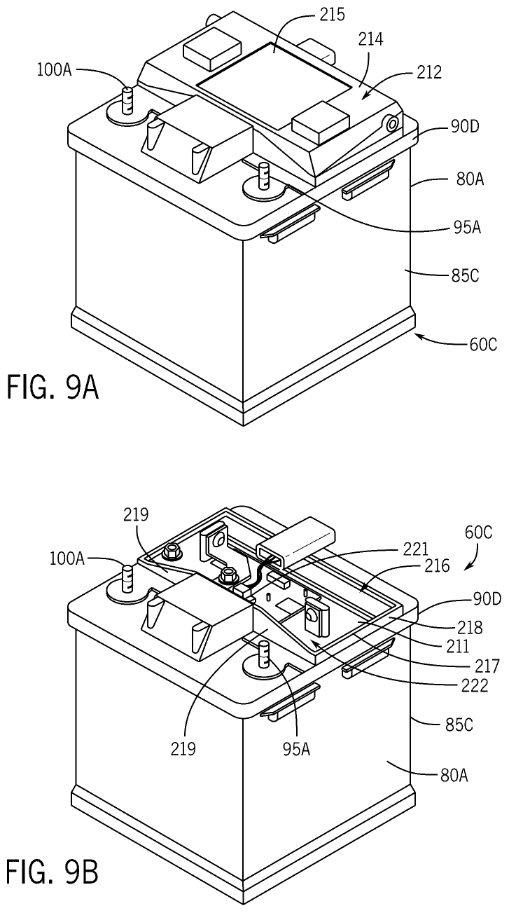

With reference to FIGS. 8A and 8B, returning to a lead-acid battery 60A, and the respective battery cell 130A, it is illustrated that a third aspect of the battery monitoring system 15C may be disposed within the battery housing 80A, thereby resulting in a first aspect of a battery module 60B. The second aspect of the battery monitoring system is an integrated battery monitoring system. The battery monitoring system 15C comprises at least one feature of the battery systems of 15A and 15B. With that, the battery monitoring system 15C comprises battery control module 65C, a communication module 160A, and a measurement device 165A. However, in certain implementations, the battery monitoring system 15C, or a component thereof, may be located remote from the battery module 60B, for example within a separate housing. The battery module 60B includes an array 170 of the battery cells 130A. The battery cells 130A are connected in series to the battery control module 65C. The battery control module 65C includes the communication module 160A configured to receive and/or transmit signals from external devices. Alternatively, the communication module 160A may be separate from and electrically coupled to the battery control module 65C. Certain constructions of the battery monitoring system 15C may include a communication module 160A that includes a transmitter (the transmitter may comprise the transceiver 210A, FIG. 8C, capable of communicating through radio frequency signals, such as via a Bluetooth connection, a wireless local area network connection, a cell phone data connection (e.g., code division multiple access), or other suitable connection.

As illustrated in FIG. 8A, each measurement device 165A is at least one of physically and electrically coupled to a battery cell 130A at one or more of battery cell posts (172, 173) of the battery cell 130A. Each measurement device 165A includes one or more sensors configured to monitor an operational parameter of the respective battery cell 130A, and a measuring device transmitter 205, FIG. 8C, to output a signal indicative of the operational parameter, battery health data, of the battery cell 130A and battery module 60B to the battery control module 65C.

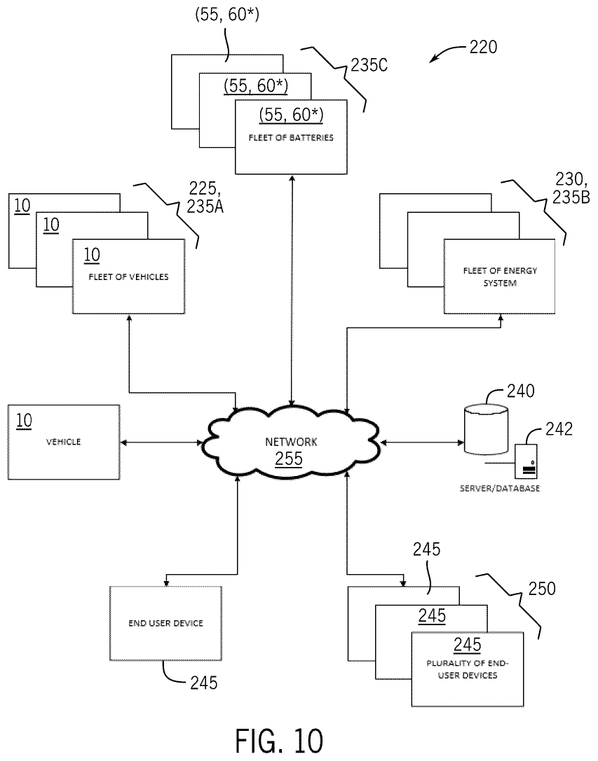

As illustrated in FIG. 8B, a schematic view of a battery cell 130A having a measurement device 165A. Each measurement device 165A includes a first lead 175 coupled to the positive post 172 of a respective battery cell 130A, and a second lead 180 coupled to the negative battery post 173 of the battery cell 130A. In certain embodiments, the measuring device transmitter 205, FIG. 8C, is communicatively coupled to the first and second leads 175 and 180 and configured to output the signal indicative of the operational parameter via modulation of a power signal output by the battery cell 130A. In further embodiments, a measuring sensor 185, FIG. 10, (e.g., voltmeter and/or amp meter and/or ohmmeter) may be coupled to the first and second leads 175 and 180 and configured to measure a parameter of the power (e.g., voltage and/or current and/or capacitance). Although the illustrated construction includes one self-contained measurement device 165A for each battery cell 130A, some constructions may include more or fewer measurement devices 165A. For example, the battery measurement devices 165A that are configured to monitor or store overall battery parameters for the battery module 60B, FIG. 8A, (e.g., battery voltage rather than cell voltage, battery temperature, battery type, battery size, etc.). In some constructions, the measurement devices 165A may be stored in suitable locations other than those illustrated. For example, the measurement devices 165A may be located on the battery housing 80A whether internal and/or external to the battery housing 80A, or within the cavity 120A, FIG. 4, and used to monitor the temperature within the battery housing 80A including the battery cells individually. Additionally, one or more measurement devices 165A may be included within the battery control module 65C, and may measure the voltage of the battery, a cell 130A, or a group of battery cells 130A.

With reference to FIG. 8C is a schematic diagram of an implementation of the battery monitoring system 15C, including the measurement device 165A and the battery control module 65C. As illustrated, the measurement device 165A includes a voltmeter 185 (or other sensor for measuring amperage or capacitance or a combination of voltage, amperage, and/or capacitance) electrically coupled to the first lead 175 and to the second lead 180. The first lead 175 is electrically connected to the positive battery terminal 95A and the second lead 180 is electrically connected to the negative battery terminal 100A, and because of such the sensor 185 measures the voltage, current, and/or capacitance across the respective battery cell 130A. In the illustrated implementation, the voltmeter 185 is communicatively coupled to a processor 70B. The processor 70B is configured to receive a signal from the sensor 185 indicative of the measured voltage, current, and/or capacitance, and to compute the voltage, current, and/or capacitance based on the signal. For example, in certain embodiments, the sensor 185 may output an analog or digital signal(s) proportional to the measured voltage current, and/or capacitance. In such embodiments, where an analog signal is outputted, the processor 70B may be configured to convert the analog signal into a digital signal, and to determine the voltage based on the digital signal.

In the illustration, the measurement device 165A also includes a temperature sensor 195A communicatively coupled to the processor 70B. The temperature sensor 195A outputs a signal indicative of the battery cell temperature, and the processor, a microprocessor, 70B determines the cell temperature of the battery cell 130A based on the signal. For example, in certain embodiments, the temperature sensor 195A may output an analog or digital signal(s) proportional to the measured temperature. In such embodiments, where an analog signal is outputted, the processor 70B may be configured to convert the analog signal into a digital signal, and to determine the temperature based on the digital signal.

While the illustrated measurement device 165A includes a sensor 185 and a temperature sensor 195A, it should be appreciated that alternative constructions may include additional sensors configured to monitor other operational parameters of the battery cell 130A as noted. For example, the measurement device 165A may include a sensor configured to measure the state of charge within the battery cell 130A, and/or an ammeter configured to determine current being provided by the cell. The measurement device 165A may include a pressure sensor configured to detect an excessive pressure within a gas venting region, for example. The measurement device 165A may include an ohmmeter, or other sensor configured to monitor an electrical, physical, or chemical parameter of the battery cell 130A.

The illustrated measurement device 165A also includes a memory 75B communicatively coupled to the processor 70B. The memory 75B may be configured to store battery cell identification information, operational parameter history information, battery cell type information, and/or usage information. For example, a unique identification number may be associated with each battery cell 130A and stored within the memory 75B. In such a configuration, the battery control module 65C may identify a particular battery cell 130A based on the unique identification number, thereby facilitating communication between the measurement device 165A and the battery control module 65C. The memory may also be configured to store historical values of measured operational parameters. For example, the memory 75B may store the maximum voltage, current, and/or capacitance, or other measurements(s) measured by the sensor 185, or other sensors as described, and/or the maximum temperature measured by the temperature sensor 195A and/or the maximum pressure as described. Such information may be useful for diagnosing faults within the battery cell 130A. Furthermore, the memory 75B may be configured to store usage information, such as average load, maximum load, duration of operation, or other parameters that may be useful for monitoring the operational status of the battery cell 130A. Similar information may be stored in the battery monitoring unit for the battery module.

In the illustration, the measurement device 165A includes a transmitter 205 configured to output the operational parameter (e.g., voltage, temperature, etc.) to the battery control module 65C. As illustrated, the transmitter 205 is communicatively coupled to the first lead 175 and to the second lead 180. Consequently, the transmitter 205 is communicatively coupled to a first power transmission conductor 207 extending between the positive post 172 of the battery cell 130A and the battery control module 65C, and to a second power transmission conductor 208 extending between the negative post 173 of the battery cell 130A and the battery control module 65C. The first and second power transmission conductors (207, 208) are configured to transfer a power signal from the battery cell 130A to the battery control module 65C. In one implementation, the transmitter 205 is configured to output a signal indicative of the operational parameter (e.g., voltage, current, capacitance, and/or temperature, etc.) via modulation of the power signal. Specifically, the battery cell 130A is configured to output a direct current (DC) signal to the battery control module 65C. The transmitter 205 is configured to modulate the DC signal with an alternating current (AC) signal indicative of the value of the operational parameter. Any suitable data-over-power modulation, superposition, or transmission scheme may be employed.

As illustrated, the battery control module 65C includes processor 70C, a memory, and a transceiver 210A (comprising the communication module 160A) electrically coupled to the power transmission conductors (207, 208). The transceiver 210A may be configured to receive wireless signals from the transmitter 205 and/or external sources. In such implementations, the wireless communication link between the transmitter 205 and the transceiver 210A may be bidirectional. It is contemplated that the processor 70B and memory may each be a single electronic device or formed from multiple devices. Exemplary processors and memories will be discussed in further detail below.

Before moving to other components, it should be understood by somebody skilled in the art that the battery controller may include additional conventional elements typically found in a battery. Further discussion regarding these components is not provided herein since the components are conventional and their operation are conventional. Such may include the mitigation of carrier signals.

With reference to FIGS. 9A-9D , third and fourth aspects of the battery module (60C, 60D) are illustrated. As illustrated in FIGS. 9A and 9B, the third aspect of the battery module 60C, which is a lead-acid battery, comprises a housing 80A. The battery module 60C has a housing 80A that meets the German Industrial Standard (DIN) battery size of H3. As illustrated in FIGS. 9C and 9D, the fourth aspect of the of the battery module 60D, which is a lead acid-battery, comprises a housing 80A. The battery module 60D has a housing 80A that meets the German Industrial Standard (DIN) battery size of H6.

As further illustrated in FIGS. 9A-9D, the housing 80A includes a housing base 85C and a cover 90D. The cover 90D is secured to the housing base 85C, for example, by heat sealing and/or mechanical means. The housing 105 further includes a battery management system, or battery monitoring system, (BMS) base 211 and a BMS cover 212. The BMS cover 212 is secured to the BMS base 211, for example, by heat sealing the BMS cover 212 to the BMS base 211. Alternatively, the BMS cover 212 is connected to the BMS base 211 using a number of fasteners (e.g., screws, bolts, chemical fasteners). For the construction shown, the BMS base 211 is integrally formed with the cover 90D. Also for the construction shown, the BMS cover 212 is a two-component cover having a first cover portion (or first cover) 214, and a second cover portion (or second cover) 215. The battery module (60C, 60D) further includes terminals (95A, 100A) protruding through or on the housing (e.g., the cover 90D as shown). The terminals (95A, 100A) are provided on the cover 90D for connecting or coupling the battery system 100 to electrical loads (e.g., a vehicle electrical system). A communication connecter 126 (e.g., for coupling to a vehicle connector) protrudes through or on the BMS cover 212.

As illustrated in FIGS. 9B and 9D, the BMS cover 212 may be removed. Using FIG. 9B as an example, the cover 90D includes a platform 216 integrally formed with the cover 90D. The platform 216 includes a shelf surface 217 and a shelf wall 218. The BMS cover 212 includes an edge and an inner wall. The edge is directly connected to the shelf surface 217, and the inner wall is near the shelf wall 218. More specifically, the BMS cover 212 can use the shelf wall 218 to help align the edge of the BMS cover 212 onto the shelf surface 217. In the shown construction, the edge is continuous on a perimeter of the BMS cover 212 and the edge is in continuous contact with the shelf surface 217 (best shown in FIG. 5). The BMS cover 212 can then be sealed with the shelf surface 217 and or shelf wall 218. Also shown in FIG. 6, the platform 216 can include multiple ramps 219 and an outer wall 221 to help align the BMS cover 212 with the platform 216.

With reference to FIG. 9E, a block diagram of the third and fourth aspects of the battery module (60C, 60D) is illustrated. The third and fourth aspects of the battery module (60C, 60D) provide for a fourth aspect of the battery monitoring system 15D. An illustrative example of the fourth aspect of the battery monitoring system 15D is provided at FIG. 9E, and it is contemplated variations of such may be provided. The battery module (60C, 60D) includes an array of battery cells 130A electrically connected to a fourth aspect of the battery control module, or BMS, 65D. The BMS 65D includes a communication module 160B configured to receive and/or transmit signals from external devices (e.g., a vehicle). For example, certain constructions of the BMS 65D include the communication module 160B that includes a transmitter capable of communicating through radio frequency signals, such as via a Bluetooth connection, a wireless local area network connection, a cell phone data connection (e.g., code division multiple access), or other suitable connection. The communication module 160B can alternatively or additionally use a wired-communication scheme. Example wired communication standards include controller area network (CAN), local interconnect network (LIN), on-board diagnostic (e.g., OBD-II), recommended standard (e.g., RS-485), etc.

In the illustration, the BMS 65D includes a battery measurement device/circuit 165B. The battery measurement device/circuit 165B includes one or more sensors configured to monitor the battery cells 130A and is configured to output a signal indicative of parameters (e.g., cell voltages) to the BMS 65D. As illustrated, leads are coupled to various terminals (or lugs). Depending on the attached leads, the measurement device 165B can acquire individual cell voltages, group cell voltages, and/or battery voltages for the battery module (60C, 60D). For the shown example, the measurement circuit 165B is located in the BMS compartment 222.

For the battery system 15D, the measurement circuit 165B can include voltage sensors (e.g., voltmeters) electrically coupled to the various leads provided to the measurement circuit 165B. Because the first lead is electrically connected to the positive post 172 and the second lead is electrically connected to the negative post 173, the measurement device 165B the voltage, or other measurement as previously described, across the battery cell 130A. The measurement device 165B is coupled to a processor 70D and a memory 75C. The processor 70D receives a signal from the voltage sensor indicative of the cell voltage, and to determine the cell voltage based on the signal. For example, in certain implementations, the voltage sensor outputs an analog signal proportional to the sensed voltage. In such implementations, the processor 70D may be configured to convert the analog signal into a digital signal, and to determine the voltage based on the digital signal. The memory 75C may be configured to store battery cell identification information, operational parameter history information, battery cell type information, and/or usage information. For example, a unique identification number may be associated with each battery cell 130A and stored within the memory 75C.

It should be appreciated that the battery system 15D/battery module (60C, 60D) includes additional sensors configured to monitor other operational parameters of the battery cells 130A and or the battery module (60C, 60D). The measurement circuit 165B can include a temperature sensor 195B. The temperature sensor 195B outputs a signal indicative of the battery cell temperature. For example, the temperature sensor 440 may output an analog signal proportional to a measured temperature. It should also be appreciated that alternative constructions may include additional sensors configured to monitor other operational parameters of the battery cell 130A. For example, the measurement circuit 165B may include a sensor configured to measure the state of charge within the battery cell 130A, a current sensor 165C configured to determine a current being provided by the battery cell 130A, a pressure sensor configured to detect an excessive pressure within the battery cell 130A, an acid density measurement to measure acid density in a battery cell 130A, and/or other sensors configured to monitor an electrical, physical, or chemical parameter of the battery cell 130A.

The processor 70D can include a component or group of components that are configured to execute, implement, and/or perform any of the processes or functions described herein for the BMS 65D or a form of instructions to carry out such processes or cause such processes to be performed. Examples of suitable processors include a microprocessor, a microcontroller, and other circuitry that can execute software. Further examples of suitable processors include, but are not limited to, a core processor, a central processing unit (CPU), an array processor, a vector processor, a digital signal processor (DSP), a field-programmable gate array (FPGA), a programmable logic array (PLA), an application specific integrated circuit (ASIC), math co-processors, and programmable logic circuitry. The processor 70D can include a hardware circuit (e.g., an integrated circuit) configured to carry out instructions. In arrangements in which there are a plurality of processors, such processors can work independently from each other, or one or more processors can work in combination with each other.

The memory 75C includes memory for storing one or more types of instructions and/or data. The memory 75C can include volatile and/or non-volatile memory. Examples of suitable memory include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, disks, drives, or any other suitable storage medium, or any combination thereof. The memory 75C can be a component of the processor 70D, can be operatively connected to the processor 70D for use thereby, or a combination of both.

In one or more arrangements, the memory 75C can include various instructions stored thereon. For example, the memory 75C can store one or more instruction (e.g., software or firmware) modules. The instruction modules can be or include computer-readable instructions that, when executed by the processor 70D, cause the processor 70D to perform the various functions disclosed for the battery system 100. While functions may be described herein for purposes of brevity, it is noted that the functions for the battery system 15D/battery module (60C, 60D) are performed by the processor 70D using the instructions stored on or included in the various modules. Some modules may be stored remotely and accessible by the processor 70D using, for instance, various communication devices and protocols.

The memory 75C may also be configured to store battery identification information, battery operational parameter history information, battery type information, and/or battery usage information. The memory 75C may be further configured to store, for each battery cell 130A, battery cell identification information, battery cell operational parameter history information, battery cell type information, and/or battery cell usage information. For example, a unique identification number may be associated with each battery cell 130A and stored within the memory 75C. In such a configuration, the battery monitoring unit may identify a particular battery cell 130A based on the unique identification number, thereby providing more context to the measured parameters. The memory 75C may also be configured to store historical values of measured operational parameters of the battery module (60C, 60D) and the battery cells 130A. For example, the memory 75C may store the maximum and/or minimum voltage measured by a voltage sensor. Such information may be useful for diagnosing faults within a battery cell, as will be discussed in some of the further constructions below. Furthermore, the memory 75C may be configured to store usage information, such as average load, maximum load, duration of operation, or other parameters that may be useful for monitoring the operational status of the battery module (60C, 60D) and/or battery cells 130A. Similar information may be stored in the BMS 65D for combinations of battery cells 130A (e.g., cells 1-3 and cells 4-6).

The battery module (60C, 60D)/battery system 15D also includes a communication (or connector) port 448 for connecting a communication cable to the housing 105. The communication port 448 can promote communication between the battery module (60C, 60D)/battery system 15D and an external apparatus, such as a vehicle control module if the battery module (60C, 60D)/battery system 15D is used in a vehicle.

Before moving to other components, it should be understood by somebody skilled in the art that the battery monitoring unit may include additional conventional elements typically found in a battery module/system or a monitoring unit. Further discussion regarding these components is not provided herein since the components are conventional and their operation are conventional.

During one operation of the battery module (60C, 60D)/battery system 15D, each measurement circuit 165B monitors a cell voltage of each respective battery cell 130A the measurement circuit 165B is associated with. The measurement circuit 165B can sense other parameters associated with the battery module (60C, 60D)/battery system 15D, such as a total battery voltage, various combinations of battery cell voltages, a total battery current, a total battery charge, etc. Analog value or processed value can be provided to the BMS 65D by the measurement circuit 165B. Based on the acquired parameters and related values, the BMS 65D can determine a state of health of the lead-acid battery module (60C, 60D)/battery system 15D, particularly the battery module (60C, 60D) and the battery cells 130A. Further based on the acquired parameters and related values, the BMS 65D can determine a state of function of the lead-acid battery system (e.g., readiness in terms of usable energy by observing state-of-charge in relation to the available capacity), particularly the battery and battery cells. By monitoring cell voltage, the BMS 65D can identify a potentially faulty cell, thereby identifying a possible issue for the lead-acid battery module (60C, 60D) sooner than an external (e.g., vehicle) control unit can identify a possible issue through the total battery voltage. The lead-acid battery module (60C, 60D) herein can also provide better prediction capabilities using the additional voltage information related to the individual battery cells 130A. By extension, this applies to the other possible cell parameters (discussed above) sensed by the measurement devices 165B and the BMS 65D.

The information related to the lead-acid battery system 15D and the state of the lead-acid battery module (60C, 60D) can also be communicated through a wire connection and/or through wireless communication. For example, information may be communicated to the vehicle control module, which can provide information to the driver via the indicator panel. Alternatively, an analysis tool can be coupled (either wireless or direct connection) to the lead-acid battery system 100 for communicating with the BMS 65D, and more specifically obtain information from the memory 75C.

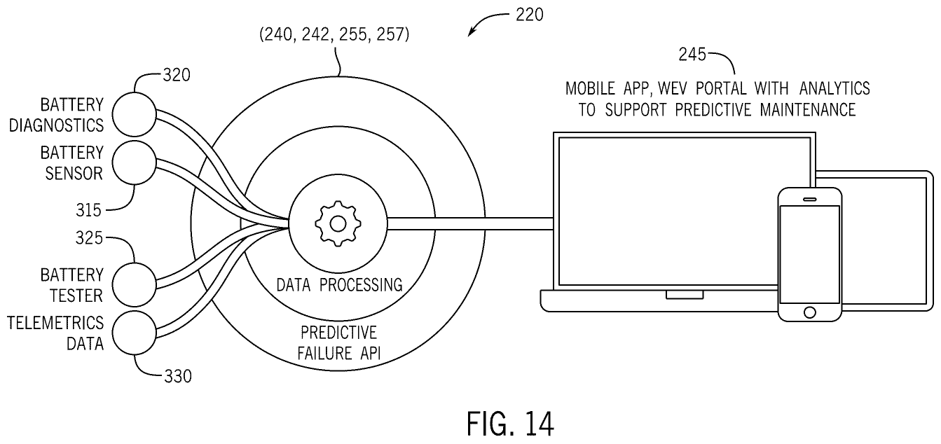

With reference to FIG. 10, a block diagram of a battery replacement system 220 is illustrated. When proceeding forwarding, Applicant shall reference battery 60A, and battery modules 60B, 60C, and 60D collectively as “battery modules” with item number “60*” where referencing to the grouping is preferred for clarity and individually where individual referencing is preferred for clarity. The battery replacement system 220 includes a vehicle 10 (similar to the vehicle of FIG. 1) that includes one or more battery modules (55, 60*), FIG. 1, a first fleet (or group) 235A of battery modules (55, 60*) in a plurality of vehicles 225, a second fleet (or group) 235B of battery modules (55, 60*), FIG. 1, in a plurality of nonvehicle energy systems 230, a third fleet (or group) 235C of battery modules (55, 60*) for use (e.g., purchase and/or lease), a battery replacement server 240 and database 242, an operator end-user device 245 for the vehicle 10, a plurality of end-user devices (as to end-user device, 245) 250, and a network 255. As discussed above, a battery module (55, 60*) for a device, such as for the vehicle 10, may include a battery monitoring system (15A, 15B) that monitors the battery. With respect to FIG. 10, the monitoring system (15A, 15B) may send the battery information to a remote server 240 or device 245 (e.g., through the network 255, which can be the Internet among numerous other networks). The battery information can be further analyzed by the server 240. The analysis and monitoring of the battery module (55, 60*) can be for an estimated end of life based on electrical, chronological, and/or chemical parameters of the battery (collectively, battery information). The analysis and monitoring of the battery module (55, 60*) may apply historical battery data of batteries of the same or similar battery type, battery size, battery make, and/or battery model stored in the database 242 and/or the server 240 in general. Specifically, the historical battery data comprises at least one battery sensor data (315, FIG. 14) of historical battery modules, at least one battery diagnostic (320, FIG. 14) of the historical battery modules, at least one battery tester data (325, FIG. 14) of the historical battery modules, and/or at least one telemetric data (330, FIG. 14) of the historical battery modules, where the historical battery modules have at least substantially similar of at least one of battery type, battery size, battery make, and battery model. End of life estimations and battery from the analyzed information, and/or battery information can be communicated to the vehicle operator (e.g., via the operator-controlled end-user device 245). Additionally, the server 240 may send other information to the user, such as suitable replacement battery modules (55, 60*); locations of battery modules (55, 60*) for lease, locations for exchange of battery modules (55, 60*), or purchase of a replacement battery modules (55, 60*); and/or inventories or prices of local and internet stores carrying suitable replacement battery modules (55, 60*).

Monitoring various parameters of the battery module (55, 60*) and/or each battery cell (130A, 130B) provides data for efficiently operating the battery, and/or for determining an estimated end of life (or life estimation) for the battery module (55, 60*). For example, in certain implementations, certain parameters of the battery, such as a time of use, a time since manufacture, the temperature of each battery cell, or group of cells, a cell voltage (and/or current and/or power and/or capacitance), a cell-group (130A, 130B) voltage (and/or current and/or power and/or capacitance), a module (55, 60*) voltage (and/or current and/or power and/or capacitance), and combinations thereof may be monitored. These parameters, data, (315, 320), FIG. 14, and information may be used to determine an estimated end of life of the battery.

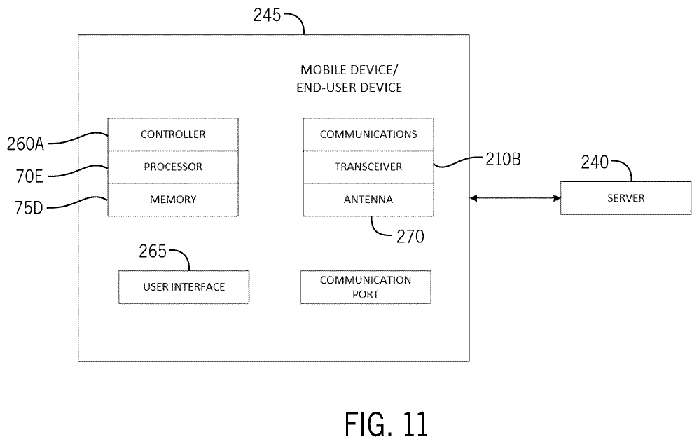

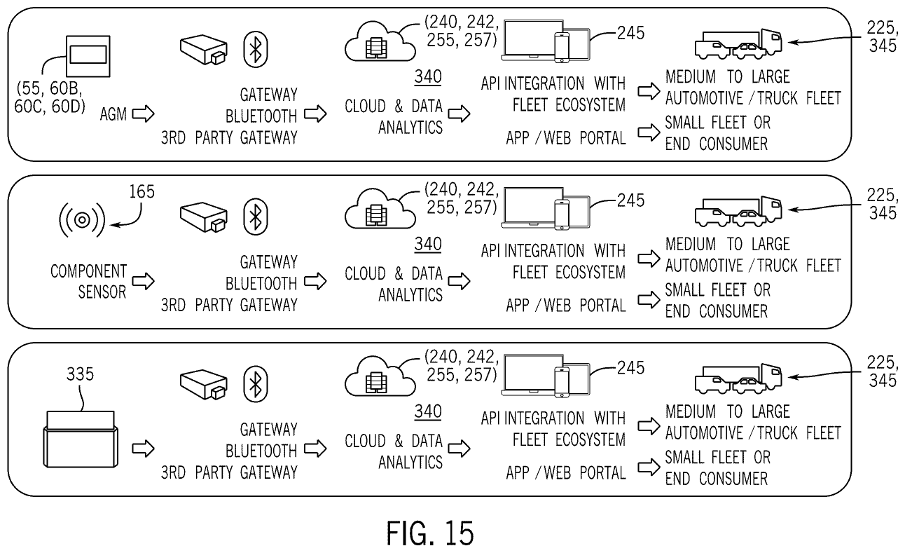

The battery replacement system 220 includes multiple groups of batteries (or battery fleets) (235A, 235B, 235C). Three battery fleets (235A, 235B, 235C) are represented in FIG. 11. The system 220 may comprise more than three battery fleets or less than three battery fleets as described. A battery fleet (235A, 235B, 235C) includes a plurality of battery modules (55, 60*), which in turn may include a subset group of battery modules (55, 60*). The first fleet of batteries 235A is the plurality of batteries currently being used by the plurality of vehicles 225. The second fleet of batteries 235B is the plurality of batteries used by the plurality of non-vehicular energy systems 230. The server 240 can monitor and store data (315, 320), FIG. 14, from the battery modules (55, 60*) of the first and second fleets (225, 230) for review of a respective battery module with individual battery data for estimating the end of life of the respective battery module (55, 60*), and for data mining purposes where data (315, 320), FIG. 15, from the same or similar batteries, as described, may be applied in the analysis of the estimating the end of life of the respective battery(s)/battery module(s) further refining the capabilities of estimating the end of life of the battery(s)/battery module(s). The third fleet of batteries/battery modules 235C are for future use (e.g., purchase and/or lease) by the plurality of vehicles 225 or the plurality of energy systems 230. The third fleet 235C may be a commercially available grouping of battery modules (55, 60*) placed inside or outside of desired location(s). For example, a portion of the battery/battery module fleet 235C may be placed within a retail establishment, such as an auto parts store, retail store, or any other desired commercial location. However, due to the nature and configuration of the system 220, it may also be placed in outside environments, such as in front of retail establishments, at desired locations in service stations, and so forth so that transactions may be performed at hours other than those during which a conventional retail establishment is open for business.

The battery replacement system 220 includes the vehicle operator end-user device 245, which allows the vehicle operator to receive information from the server 240, and search for, identify, and select appropriate battery modules (55, 60*) for their needs. The end-user device 245 provides for viewing of a battery health, the estimation the end of life of the respective battery(s), and replacement and/r exchange options and locations for the respective battery(s). The end-user device 245 preferably allows not only for some degree of education of the consumer, but also for selection of the replacement and/or exchange of batteries (55, 60*), performance of financial transactions for the purchase of a replacement or exchange battery module(s) (55, 60*), and so forth.

With reference to FIG. 11, a schematic representation of a portion of the vehicle operator end-user device 245, shown in FIG. 10, is illustrated. The end-user device 245 may be an electronic device or mobile electronic device that may execute an application (or app). The end-user device 245 may be a mobile electronic device or a stationary electronic device.

The end-user device 245 has a controller, including a processor and a memory. While the arrangement of FIG. 11 shows a single controller 260A, processor 70E, and memory 75D, it is envisioned that many other arrangements are possible.

The processor 70E can include a component or group of components that are configured to execute, implement, and/or perform any of the processes or functions described herein for the end-user device 245, or a form of instructions to carry out such processes or cause such processes to be performed. Examples of suitable processors are discussed below. The memory 75D can include volatile and/or non-volatile memory. Examples of suitable memories are also discussed below. The memory 75D can be a component of the processor 70E, can be operatively connected to the processor for use thereby, or a combination of both. The memory 75D may include modules having computer-readable instructions that, when executed by the processor, cause the processor to perform the various functions disclosed for the module. While functions may be described herein for purposes of brevity, it is noted that the functions for the end-user device are performed by the logic/memory components using the instructions stored on or included in the various modules.

Before moving to other components of the end-user device, it should be understood by somebody skilled in the art that the controller 260A includes many additional conventional elements typically found in a mobile electronic device. Further discussion regarding these components is not provided herein since the components are conventional.

The end-user device 245 may include a user interface 265. The user interface 265 can include an input apparatus and an output apparatus (each not shown in the figures). The input apparatus includes a device, component, system, element, or arrangement or groups thereof that enable information/data to be entered into the electronic device from a user. The output apparatus includes any device, component, or arrangement or groups thereof that enable information/data to be presented to the user. The input apparatus and the output apparatus can be combined as a single apparatus, such as a touch screen commonly used by many mobile electronic devices.

The end-user device 245 communicates wirelessly (e.g., with the sever) via a radio. An example of a radio includes a cellular radio, which allows the electronic device to generally communicate over a cellular communication network. In one implementation, the radio includes a transceiver 210B, coupled to at least one of the controller, processor, memory and user interface, for transmitting and receiving signals to and from the end-user device 245, via an antenna 270 coupled to the transceiver 210B. The transceiver can be separate to or part of the controller. Other radios, e.g., a Wi-Fi radio, can be included with the electronic device.

The end-user device 245 executes an application (or app), which is stored in memory 75D. An application or app includes, but is not limited to, a software application. Generally, apps are available through app stores such as Apple's iTunes®, Google's Play Store®, Microsoft's App Store™, Blackberry®, and so forth. Apps are usually run on mobile-based operating systems running on iPhones®, iPads®, Android® Phones, Android® Tablets, Apple TV®, Google TV®, and many other similar devices, but can also be run on other operating systems, such as an operating system for a desktop computer. Operations related to the app are provided herein. The descriptions of the operations relate to their functionality are in terms of the app. This is intended to mean that the app is stored in the memory and includes processor-executable instructions that, when executed on the processor, cause the processor to perform the functionality described (in combination with other portions of the memory, as well as various hardware components of the electronic device (such as the user interface or the radio, for example)).

Before proceeding further to the server 240, it should be understood that the battery replacement system 220 includes many operators, users, consumers, etc., and as a result, the system includes a plurality of end-user devices as shown in FIG. 11.

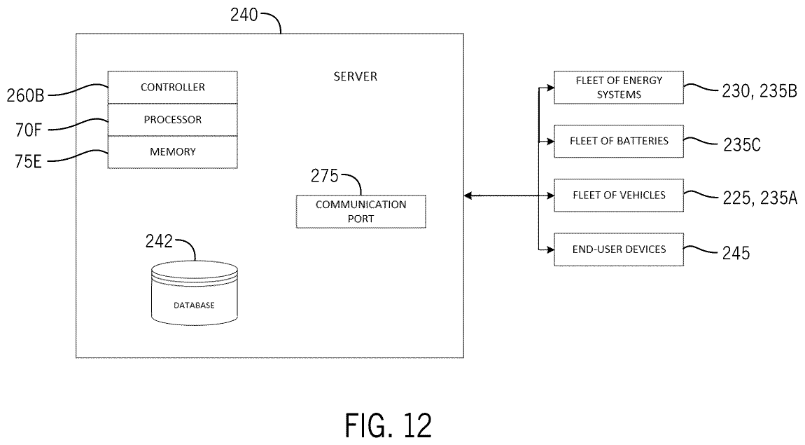

With reference to FIG. 12, a schematic representation of a portion of the server 240 and the database 242, shown in FIG. 12, is illustrated. The server has a server controller 260B, including a processor 70F and a memory 75E, the database 242, and a communication port 275 for communicating with the other devices (245, 250) of the system. However, many other arrangements are possible for the server 240 and database 242. For example, the server 240 and the database 242 can be one of a plurality of databases 242 being implemented by a plurality of servers 240, which may be generally referred to as cloud computing.

The processor 70F can include a component or group of components that are configured to execute, implement, and/or perform any of the processes or functions described herein for the server, including the database, or a form of instructions to carry out such processes or cause such processes to be performed. The memory 75E can include volatile and/or non-volatile memory. The memory 75E can be a component of the processor 70F, can be operatively connected to the processor 70F for use thereby, or a combination of both. The memory includes modules having computer-readable instructions that, when executed by the processor, cause the processor to perform the various functions disclosed for the module. While functions may be described herein for purposes of brevity, it is noted that the functions for the server and database are performed by the logic/memory components using the instructions stored on or included in the various modules.

With continued reference to the FIG. 12, the server 240 includes the database 242. The database 242 is, in one implementation, an electronic data structure stored in the memory 75E or another data store and that is configured with routines that can be executed by a processor for recording (or storing) data (315, 320), FIG. 14, analyzing stored data, providing stored data, organizing stored data, and so on. Thus, in one embodiment, the database 242 stores data used by the server 240, and more broadly the system 220, in executing various functions.

In certain embodiments, the server 240 includes modules for one or more following functions:
acquiring data (315, 320), FIG. 14, from a plurality of sources, such as the various fleets of battery modules (235A, 235B, 235C, etc.);
calculating a theoretical end of life determination, or life estimation, for a battery module(s) (55, 60*);
monitoring battery modules (55, 60*) in use within a defined group of end-use applications for scenarios;
pooling collected data from a plurality of sources for data mining and analysis;
collecting one or more of conditional stresses imparted into or on a group of battery modules (55, 60*), the conditional stresses may comprise of humidity, temperature, location, elevation, and/or load variants;
determining a rate of change for at least part of the collected conditional stresses of the battery modules (55, 60*);
revising the calculated theoretical end of life determination of the battery modules (55, 60*) based on the pooled collected data;
determining a rate for enterprise acceptability for a plurality of battery modules (55, 60*), and replacing individual or groups of battery modules (55, 60*) when the enterprise rate exceeds the rate of properly functioning group of battery modules (55, 60*);
acquiring data from deconstructed battery modules (55, 60*);
valuating the acquired data of the deconstructed battery modules (55, 60*) against the collected data.

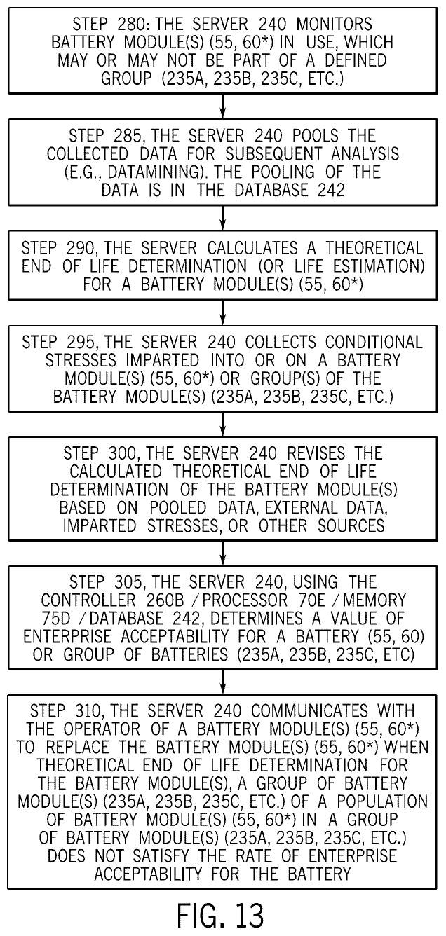

With reference to FIGS. 10-13, a first aspect of a method of operation of the battery replacement system is illustrated. At step 280, the server 240 monitors battery modules (55, 60*) in use, which may or may not be part of a defined group (235A, 235B, 235C, etc.). The monitoring includes receiving and acquiring information/data (315, 320), FIG. 14, received from the battery modules (55, 60*) for present and/or future analysis. The data (315, 320), FIG. 14, may include voltage data, current data, capacitance data, state of charge, state of function, and/or state of health.

At step 285, the server 240 pools the collected data (315, 320), FIG. 15, for subsequent analysis (e.g., datamining). The pooling of the data is in the database 242. Pooling of data may be according to one of many factors including but not limited to battery type, similarity of battery type, battery size, similarity of battery size, battery function, similarity of battery function, battery model, similarity of battery model, battery make, and/or similarity of battery make.

At step 290, the server calculates a theoretical end of life determination (or life estimation) for a battery module(s) (55, 60*). The calculation of the theoretical end of life determination for the battery module(s) (55, 60*) can be performed by a calculation module or processor 70F/server controller 260B at the server.

At step 295, the server 240 collects conditional stresses imparted into or on a battery module (55, 60*) or group(s) thereof (235A, 235B, 235C, etc.). In certain embodiments, the conditional stresses may include humidity, temperature, location, elevation, and/or load variants. The server 240 can also determine a rate of change for at least part of the collected conditional stresses.

At step 300, the server 240 revises the calculated theoretical end of life determination of the batteries based on pooled data (315, 320), FIG. 14, external data, imparted stresses, or other sources.

At step 305, the server 240, using the controller 260B/processor 70F/memory 75E/database 242, determines a value of enterprise acceptability for a battery module (55, 60*) or group of batteries/battery modules (235A, 235B, 235C, etc.). The value of enterprise acceptability can be based on many factors, including a safety characterization, an ease of replacement characterization, and a criticality characterization.

At step 310, the server 240 communicates with the operator of a battery module(s) (55, 60*) to replace the battery module(s) (55, 60*) when theoretical end of life determination for the battery, a group of batteries/battery modules (235A, 235B, 235C, etc.), or a population of battery modules (55, 60*) in a group thereof (235A, 235B, 235C, etc.) does not satisfy the rate of enterprise acceptability for the battery module (55, 60*). With reference to FIGS. 1-13, in certain embodiments, a method/process may use conditional stresses to determine thresholds for making replacements to one or more battery modules (55, 60*) of one or more vehicles 10 from a battery fleet system (235A, 235B, 235C, etc.). Vehicles 10 may be defined by a group 225. For example, long-distance vehicles, commercial vehicles, emergency vehicles, agricultural vehicles, and/or any other group of vehicles specialized for a specific function or purpose. Accordingly, the groups of vehicles 225 may have their own thresholds for when and if a conditional stress warrants a replacement of one or more battery modules from the vehicle or vehicles from a battery fleet. One example threshold can be based on a safety concern. For a specific example, a particular fleet of batteries is in a climate that is experiencing severe cold such that the determination of replacement is varied for that fleet. Another example threshold can be based on an ease of replacement characterization. For a specific example, a long-haul truck may be on the road for extended periods such that an each of replacement is difficult. Again, a determination of replacement may be varied so that the risk of the long-haul truck being on the road is lower. Another example threshold is criticality. For a specific example, a fleet of ambulances may require that even the slightest hint of potential failure leads to a replacement determination.

In certain embodiments, due to the differences in thresholds for if and when a replacement for battery module (55, 60*) is to occur, a priority protocol may be used to determine which vehicles 10 have priority for battery modules (55, 60*) to be replaced over other vehicles 10. Priority protocols may be based on type of vehicle group 225 (commercial, emergency, agricultural, car rental, tactical, construction etc.) , status of the state of charge of a battery module (55, 60*), status of state of function for a battery module (55, 60*), status of state of health for a battery module (55, 60*), transaction amount for battery module (55, 60*) replacement request, conditional stress priority, and or other conditional stresses.

In certain embodiments, a conditional stress for a defined group of vehicles may depend upon the time of the day or the day of the week, statistical, simulated use patterns, predicted use patterns, historical use patterns, vehicle reservations, or a variety of other factors.

In certain embodiments, a conditional stress for a defined group of vehicles 225 may depend upon the use of the vehicle group 225. For example, an emergency vehicle 10 such as an ambulance, may require higher thresholds for battery module reliability (state of charge, age of battery, durability etc.) and thus require more frequent battery module replacements due to the nature of use of the vehicle than a general maintenance vehicle 10.

In certain embodiments, the battery fleet (235A, 235B, 235C, etc.) may comprise of individual or groups of vehicles 225 with battery modules available to be swapped out for replacement, one or more commercial stores with one or more battery modules (55, 60*), one or more vehicle fleet centers which include one or battery modules (55, 60*) individually set aside or inside other vehicles 10 within the vehicle fleet center, or any combination of the above. A method for the battery fleet (235A, 235B, 235C, etc.) as a whole will be in communication with the controller or controllers (260A, 260B, etc.) of the battery replacement system to monitor statistics of users driving practices and habits and collect and analyze the data (315, 320), FIG. 14, as part of a determination for the optimal number of battery modules (55, 60*) which should be reserved for specific group of defined vehicles 225 based on thresholds for battery replacements as well as any other priority-based thresholds.

In certain embodiments, a method for determining the proximity of an available battery module (55, 60*) for replacement relative to a user vehicle 10 and or location of a battery fleet (235A, 235B, 235C, etc.) may be implemented by one or more controllers (260A, 260B, etc.) of the battery replacement system 220. The location and/or proximity of a battery module (55, 60*) relative to user may be used as a threshold consideration for when and if to replace a battery module (55, 60*) of a vehicle 10. Information may be displayed to the vehicle user via a graphical user interface 265, auditory notification/message or any combination of visual and auditory communication of a controller device (260A, 260B, etc.) and 245.

In certain embodiments, a method for detecting and/or predicting an anomaly relating to one or more battery modules (55, 60*) of interest from a defined vehicle group or battery fleet may be implemented by one or more controllers of a battery replacement system. The anomaly or anomalies may entail the one or more battery modules (55, 60*) monitored data showing anomalous conditional stress characteristics thresholds and any combination of relevant battery characteristics. The method may continue to communicate these anomalies to cloud based database, controller or controllers of the battery fleet system and/or any authorized vehicle user of the battery replacement system. The method may also remove the one or more anomalous battery modules (55, 60*) as options for replacement of the battery module(s) (55, 60*) from the battery replacement fleet (235A, 235B, 235C, etc.). The method may also give alerts and or indications for the one or more anomalous battery modules (55, 60*) to be selected for repair if and when a battery module (55, 60*) repair meets standards for battery replacement of a defined vehicle group 225.

The system 220 may also include computer-readable media which may include any computer-readable media or medium that may be used to carry or store desired program code that may be accessed by a computer. The invention can also be embodied as computer-readable code on a computer-readable medium. To this end, the computer-readable medium may be any data storage device that can store data (315, 320), FIG. 14. The computer-readable medium can also be distributed over a network-coupled computer system 255 so that the computer-readable code is stored and executed in a distributed fashion.

The acquired data may allow for notification to third-party providers or data aggregation across multiple devices/vehicles (245, 225). In other words, the cloud analysis of battery health may store multiple battery health readings regarding battery health analysis events. The aggregation of this data may allow for various applications beyond user notification. Further analysis may be performed of the aggregate battery health data in order to facilitate further functionality. The system 220 herein may be advantageous for a variety of applications, including informing regional impact on battery health, supply chain optimization, fleet vehicles, insurance notifications, vendor supply forecasting, and the like. The system 220 could generate an analysis report (for example, by executing several data queries and transmitting the results to a software or user interface such as, but not limited to, a web-based application) across the aggregate battery status data. This may be across all devices or readers using the system 220 herein, or across selected devices (such as by region, vehicle type, particular vehicles, etc.).

The disclosed system 220 may allow for improved supply chain management. For example, if battery health is indicated as failing or marginal across a large number of vehicles within a region, suppliers may receive a notification of need regarding those batteries. Therefore, the battery failure prediction may allow for vendors to purchase certain additional battery modules (55, 60*) based on regional battery failure prediction using the system 220 herein. The system 220 herein may also help battery manufacturers predict trends in battery supply requests.

The system herein may also inform vehicle manufacturers regarding battery health trends with their vehicles. For example, if one vehicle type has a disproportionate number of battery health issues, there may be a design issue in the vehicle 10 causing a battery (55, 60), type, size, make and/or model, to fail faster.

Fleet vehicle 225 owners may likewise use aggregate information from vehicles across their fleet. In this way, the system could provide battery information across a number of particular vehicles to a centralized fleet owner report. The system could provide a time to failure estimate for battery health across the fleet of vehicles.

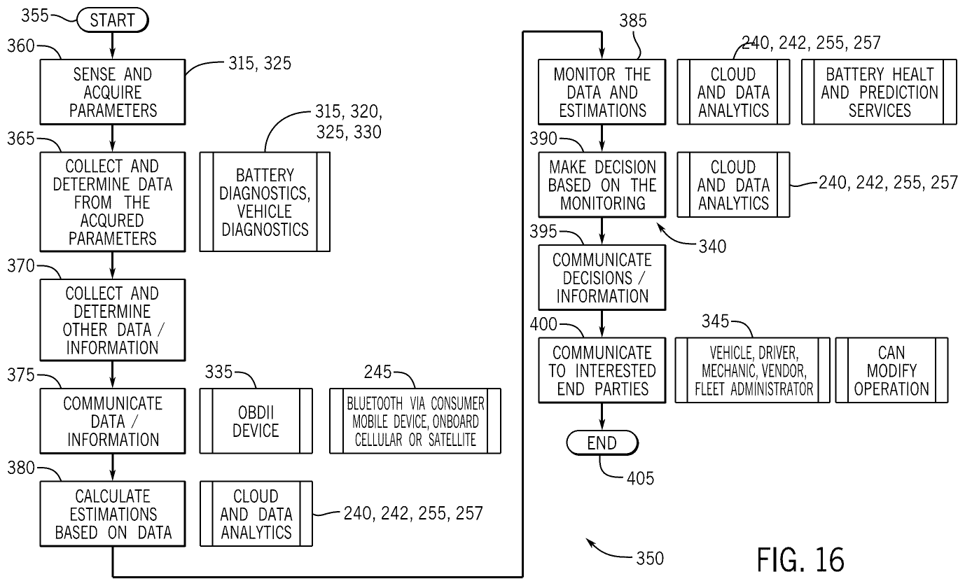

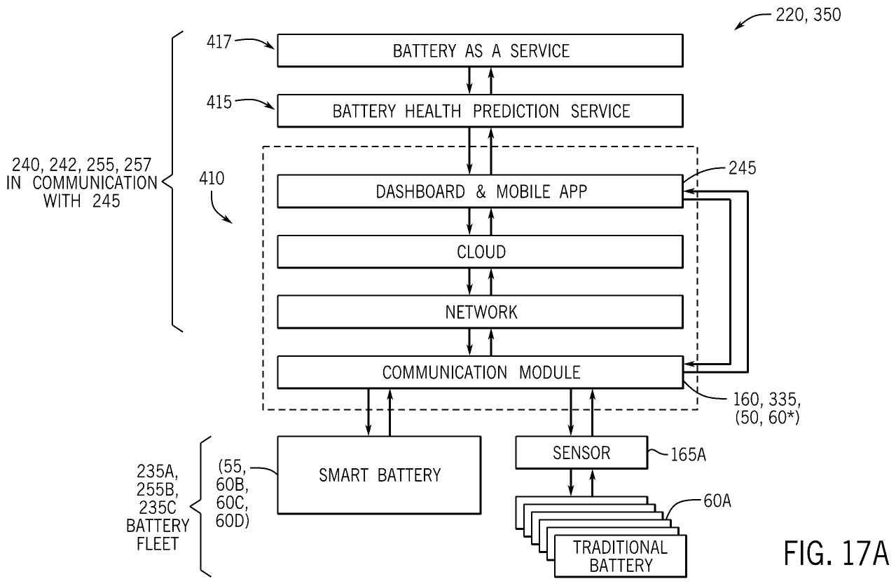

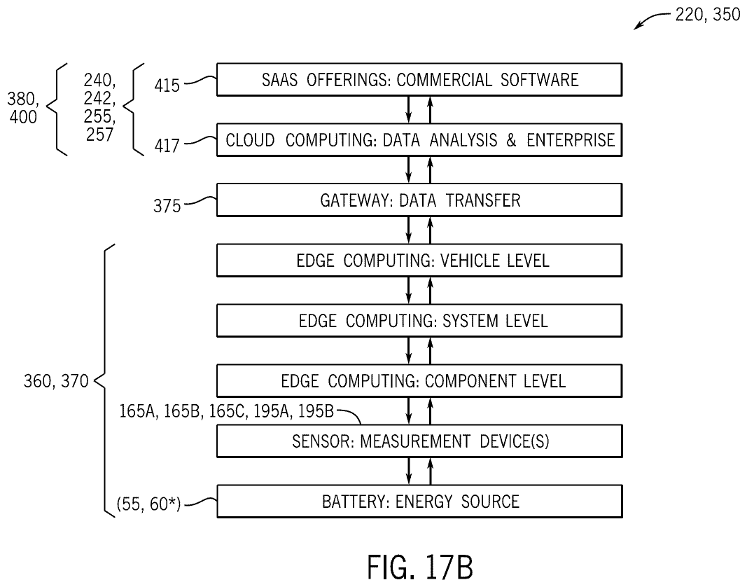

With reference to FIGS. 1 to 17B, a second aspect of the embodiment of the battery replacement system 220 and method 350 of application are illustrated. The battery system 220 may further comprise a combined leverage vehicle telematics data, OBDII or equivalent technology data 335, battery sensor 165A data, battery data (315, 320) (battery data may be provided by a smart battery and/or a battery module (55, 60*) with at least one sensor 165A, FIG. 9, electrically coupled to a computational device or server 240), and cloud based data analytics including machine learning, to improve battery health modeling and algorithms including battery state of health (SOH) accuracy. Such improvements both alert drivers and fleets 225 to replace a battery module (55, 60*) before battery failure events occur through an API, Mobile App, or Portal Dashboard and develops maintenance scheduling. As illustrated in FIG. 14, the battery system 220 as described for replacement of batteries and development of a maintenance schedule call for or request the following inputs: battery sensor data 315 (which includes but is not exclusive to voltage, current, and/or capacitance); battery diagnostics 320 (which includes but is not exclusive to state of charge and state of health); battery tester data 325; and telematics data 330. It is noted, battery sensor data may be derived from a smart battery (55, 60B, 60C, 60D) or a battery 60A with at least one sensor 165A. Vehicle parameters and vehicle diagnostics or telematics data 330 includes but are not exclusive to vehicle error codes vehicle recall summary, Global Positioning System (GPS) data, speed of the vehicle 10, idle and/or start stop time of the vehicle 10, and tire pressure for the tires associated with and attached to the vehicle 10. At least one of the battery sensor data 315, battery diagnostics 320, battery tester data 325, and telematics data 330 is sent to a cloud based aspect of the system 257 for data processing and transfer of cloud based analytics to an end-user device 245, where said end-user device can be a remote device, via an application program interface (API). It is observed the cloud based aspect of the system 257 may comprises at least one of the network 255, at least one processor 240, and at least one database 242.

As illustrated in FIG. 15, the battery replacement system 220 and method 350 described for replacement of batteries, and development of a maintenance schedule, may incorporate various components based upon the application applied. The system 220 and method incorporates the battery 60A or battery module (60B, 60C, 60D). Such a battery may require a Wi-Fi connection to operate with the battery system 220 and to operate pursuant to the method 350 as described. Alternatively, such communication is provided via direct wiring. With that, in a first application of the system and method the battery (55, 60) receives battery sensor data 315 for the battery 60A or battery module (55, 60B, 60C, 60D) on which at least one sensor 165A is coupled and applied for monitoring. Alternately, in a smart battery (55, 60B, 60C, 60D) coupled to at least one sensor 165A, at least one battery diagnostic 320 may be computed from the battery sensor data 315 for the respective battery (55, 60) on which the sensors are coupled and applied for monitoring. Further, the battery replacement system 220 and method may further incorporate an OBDII or equivalent technology 335, in place of the former applications or accompanying either or both application. Specifically, the OBDII or equivalent technology 335 may be a dongle for attachment to the vehicle (10, 225) or external system 230. The OBDII gathers battery sensor data 315, battery diagnostics 320, battery tester data 325, and vehicle diagnostics and telematics data 330 the vehicle system (ECU). Further, the OBDII or equivalent technology 335 provides for data storage of at least one of battery sensor data 315, battery diagnostics 320, and vehicle diagnostics and telematic data, 330. Each application, whether the sensor 165A, smart batter battery (55, 60) or OBDII or equivalent technology 335 requires a Bluetooth or equivalent connection to the cloud based aspect of the system 257. With that, the sensor 165A through the battery system (15A, 15B, 15C, 15D), smart batter battery (55, 60B, 60C, 60D) applying aspects similar to the battery system 15A or OBDII or equivalent technology 335 using the ECU, provides for transmission of at least one of battery sensor data 315, battery diagnostic data 320 and vehicle diagnostics or telematic data 330 to the cloud based aspect of the system 257. Such a connection to the cloud base system 255 is provided through an electrical link with the battery provider gateway device or a third-party gateway device. The cloud based aspect of the system 257 calculates and communicates the battery state marker 340 through at least one of a battery provider mobile application, web portal, and fleet ecosystem to at least one of the following entities 345: the vehicle 10 in which the battery(s) reside; the driver of the vehicle 10; the mechanic of the vehicle 10; a vendor of the battery module (55, 60*) and/or other components of the vehicle 10; and a fleet 225 administrator managing the vehicle 10 in which the battery (55, 60) resides. The fleet 225 may be an automotive fleet or a truck fleet. The fleet may have a size, which is the number of vehicles, or large as understood by those in the art or medium by those in the art, or small by those in the art. Alternatively, the entity 345 may be an individual user of the vehicle 10.

As illustrated in FIGS. 1-16, the method 350 of applying the second aspect of the embodiment of the battery replacement system. The method 350 of application of the battery system 220 which both alerts drivers and fleets to replace the battery before a failure event occurs through an API, Mobile App, or Portal Dashboard and develops maintenance scheduling is further described. This method 350 is a continuation of and/or addition to the method steps 280 to 310 as previously described. This method 350 has a starting location or position 355 where the method 350 begins prior to the steps 280 to 310, or begins after such steps, or begins concurrent with the progression of steps 280 to 310. Step 360, battery sensor (165A, 165B, 165C), the battery module (55, 60*), and or the OBDII 335 acquires the battery sensor data 315 as well as the battery tester data 325, and the electronic control unit (ECU) of the vehicle 10 or external system senses and acquires vehicle parameters. As noted, the battery sensor data 315 includes but is not exclusive to voltage, capacitance, and current of the respective battery. The battery tester data 325 includes data as to the condition of the testing unit of the battery whether incorporated in the smart battery module or extrinsic with respect to the battery module (55, 60*). As to the ECU, the vehicle parameters include but are not exclusive to vehicle error codes, vehicle recall summary, Global Positioning System (GPS) data, speed of the vehicle 10, idle and/or start stop time of the vehicle 10, and tire pressure for the tires associated with and attached to the vehicle 10. Step 365, the battery module (55, 60*) then applies at least one of the battery sensor data 315 and the battery tester data 325 from the battery module (55, 60*) for computation of battery diagnostics 320. The computation may be performed by one or a combination of a smart battery, computational device/battery system (15A, 15B, 15C, 15D) or server 240 electrically coupled to the battery module (55, 60*), or the OBDII 335, with at least one sensor. As noted, such battery diagnostics include but are exclusive to battery SOH, battery state of charge (SOC), battery state of function (SOF). The ECU concurrently or proximate in time to the calculations of the battery diagnostics 320 computes the vehicle diagnostics and the telematics data 330 applying the vehicle parameters from the vehicle 10 or external system. Such vehicle diagnostics and telematics data 330 include but are not exclusive to vehicle speed, vehicle acceleration, vehicle engine and engine component data, vehicle transmission and transmission component data, vehicle brake and braking data, vehicle exhaust efficiency and component data, and data as to wear components on the vehicle. The ECU may acquire the following vehicle parameters as well exclusive to vehicle error codes, vehicle recall summary, Global Positioning System (GPS) data, speed of the vehicle 10, idle and/or start stop time of the vehicle 10, and tire pressure for the tires associated with and attached to the vehicle 10.

Step 370, applying a combination of at one of the ECU, the battery module (55, 60*), and the OBDII 335, environmental parameters are retrieved. Environmental parameters includes but are not exclusive to location of the vehicle 10, brand or make of the vehicle, model of the vehicle, external temperatures, driving conditions (for example but not exclusive to whether an external surface on which the vehicle 10 operates has a topography that appear to be continuous or does the topography appear differentiating in height or whether the surface has a consistency promoting attraction of the wheels of the vehicle 10 or sliding of the wheels of the vehicle 10 against the external surface). It is noted environmental parameters, whether a portion of such or all such environmental parameters, can be captured by and or stored at the cloud based aspect of the system 257.

Step 375, at least one of the battery sensor data 315 and the battery tester data 325 of the battery module (55, 60*) are transferred to the OBDII or equivalent technology 335 via a remote connection. In doing so, the battery module (55, 60*) is electrically coupled to the OBDII or equivalent technology 335. It is observed a battery coupled to at least one sensor may be coupled to a communication device to provide for communication with the OBDII or equivalent technology 335. At least one of the vehicle parameters and the vehicle diagnostics and telematics data 330, are transferred to the OBDII or equivalent technology 335. In doing so, the vehicle 10 is electrically coupled to the OBDII 335 via remote connection or hardwire connection. The OBDII or equivalent technology 335 is electrically coupled to the cloud based aspect of the system 257, FIG. 15, via a Bluetooth connection between the OBDII or equivalent technology 335 and a remote device 245. Alternatively, a battery system (15A, 15B, 15C, 15D) and/or smart battery (55, 60B, 60C, 60D) may transfer at least one of the battery sensor data 315, the battery tester data 325, the vehicle parameters, the vehicle diagnostics, and telematics data 330 to the remote device 245, concurrent with, consecutive to, or in place of the OBDII 335. The remote device is electrically coupled to the cloud based aspect of the system 257, FIG. 15. The battery sensor data 315, the battery tester data 325, the vehicle parameters, and the vehicle diagnostics and telematics data 330 are electrically transferred from the remoted device to the cloud based aspect of the system 257 or directly from the battery system (15A, 15B, 15C, 15D) and/or battery (55,60) and/or OBDII 335 to the cloud based aspect of the system 257.

Step 380, servers 240 and processors 242 providing for the cloud base system 267 further calculate data analytics. The cloud based aspect of the system 257 may recalculate all or some of such battery diagnostics 320 and vehicle diagnostics and telematics data 330 calculated by the battery system (15A, 15B, 15C, 15D) and/or battery module (55, 60*) and/or the ECU. Alternatively, the cloud based aspect of the system 257 may calculate all or some of battery diagnostics 320 and vehicle diagnostics and telematics data 330 not calculated by the battery system (15A, 15B, 15C, 15D) and/or battery module (55, 60*) and/or the ECU.

Step 385, The cloud based aspect of the system 257 monitors the battery diagnostics 320 and vehicle diagnostics and telematics data 330. In doing so, the cloud based aspect of the system 257 calculates at least one estimation for the health of the battery module (55, 60*). The health of the battery is evidenced based upon the internal chemistry of the battery, the internal components of the battery, the vehicle 10 in or upon which the battery module (55, 60*) is applied, and the environmental conditions upon which the battery module (55, 60*) is applied. Environmental conditions being the road surface conditions, as previously discussed, and the external climate or weather. Thus step 385 provides battery health services and predictive review as to the replacement of the battery module (55, 60*).

Step 390, applying the calculation of the at least one estimation for the health of the battery module (55, 60*) and the predictive review as to the replacement of the battery module (55, 60*), the cloud based aspect of the system 257 applies a battery state marker 340 to the calculation of the at least one estimation for the health of the battery module (55, 60*) and the predictive review as to the replacement of the battery module (55, 60*). The battery state marker 340 is at least one of the following.
GREEN: the calculation of the at least one estimation for the health of the battery module (55, 60*) indicates the battery module (55, 60*) is in a condition of health such that the battery neither requires monitoring (wherein in monitoring is performed by the system 15) nor needs to be replaced prior to the next scheduled check in which the method 350 is applied, such equates to battery acceptance.
YELLOW: the calculation of the at least one estimation for the health of the battery module (55, 60*) indicates the battery module (55, 60*) is in a condition of health such that the battery module (55, 60*) requires monitoring (wherein in monitoring is performed by the system 15) prior to and up to the next scheduled check in which the method 350 is applied. Such monitoring includes repeating steps 360 to 390 for the respective battery. Yellow further indicates the battery may need to be replaced if the calculated condition of health such that the battery module (55, 60*) advances beyond a predetermined threshold in which a battery module (55, 60*) should be replaced.
RED: the calculation of the at least one estimation for the health of the battery module (55, 60*) indicates the battery module (55, 60*) is in a condition of health such that the battery module (55, 60*)requires replacement prior to next scheduled check in which the method 350 is applied.

Step 395, the cloud based aspect of the system 257 communicates the battery state marker 340. This communication of step 395 is provided through at least one of a battery provider mobile application, web portal, and fleet ecosystem. Where any two or three of the battery provider mobile application, web portal, and fleet ecosystem may be working in conjunction and or cooperation with one another to provide for the communication of step 395. Such communication may be provided on the remote device 245.

Step 400, the cloud based aspect of the system 257 communicates the battery state marker 340 to at least one of the following entities 345: the vehicle 10 in which the battery(s) reside; the driver of the vehicle 10; the mechanic of the vehicle 10; a vendor of the battery module (55, 60*) and/or other components of the vehicle 10; and a fleet administrator managing the vehicle 10 in which the battery module (55, 60*) resides. In doing so, the battery module (55, 60*), the smart battery module (55, 60*) or ECU may lower or raise operational output of the respective battery and/or vehicle 10 based upon the calculation of the at least one estimation for the health of the battery module (55, 60*) and the battery state marker 340. As a result, the operation of the battery module (55, 60*) may be modified in order to address and/or accommodate for the health of the battery module (55, 60*), conditions of the vehicle 10, and the external parameters. With that, the battery module (55, 60*) and/or the ECU may perform one of the following.
Determine the battery module (55, 60*)is in a condition of health such that the battery neither requires monitoring nor needs to be replaced prior to the next scheduled check in which the method 350 is applied-Green indication.
Determine the battery module (55, 60*) requires monitoring prior to and up to the next scheduled check in which the method 350 is applied. Such monitoring includes repeating steps 360 to 390 for the respective battery. Yellow further indicates the battery may need to be replaced if the calculated condition of health such that the battery module (55, 60*) advances beyond a predetermined threshold in which a battery module (55, 60*) should be replaced-Yellow indication.
Determine the battery module (55, 60*) is in a condition of health such that the battery module (55, 60*) requires replacement prior to next scheduled check in which the method 350 is applied
Red indication.

Step 405, the method 350 is completed. The method 350 is repeated at a predetermined interval throughout the operation of the battery 100 in the vehicle 10. Further, as described, the method 350 is repeated where a Yellow indication is provided by the cloud based aspect of the system 257 for the respective battery module (55, 60*), or batteries, which received the Yellow indication until the next predetermined interval application of the method 350 or such battery, or batteries, is removed from the vehicle 10.

With reference to FIGS. 8B, 9A-9E, 10, 14, 15, 16, 17A and 17B, the system 220 is further described. The system 220, which applies the method 350, as described may comprise three general components: 1) the battery modules (55, 60*) whether singularly or in a fleet (235A, 235B, 235C); 2) connected infrastructure and operations 160B; and 3) digital service offerings 415. It is understood the components as described may be combined into less than three components. It is understood the components as described may require collectively more than three components. The batteries modules (55, 60*) and fleets of batteries are as previously described. The connected infrastructure and operations 160B comprise the following: the communications module; cloud based aspect of the system 257, which may incorporate at least one processor 240 and/or at least one database 242; and battery health prediction service 415 and battery as a service 417. As previously described, the communications module provides for the communication of data information 375 to the cloud based aspect of the system 257. The communications module may comprise the communications module 160 of the battery system (15A, 15B, 15C, 15D) or other aspect of the battery system (15A, 15B, 15C, 15D), or an equivalent component in the smart battery (55, 60), and/or the OBDII or equivalent technology 335. The connected infrastructure and operations 160B further comprise a network and/or electrical communications components for electrical coupling to the cloud based aspect of the system 257 of the connected infrastructure and operations 160B. It is understood a mobile device or dashboard 245 may receive the communication of data information 375 and transfer such communication to the cloud based aspect of the system 257. Further, the connected infrastructure and operations 160B includes the cloud based aspect of the system 257, which may incorporate the network and/or at least one processor 240 and/or at least one database 242. As previously stated, the cloud based aspects of the system 257 computes and determines for the respective battery modules (55, 60*) and/or battery fleet (235A, 235B, 235C) at least one of the battery health, the enterprise of acceptability, the battery state marker 340, the battery health prediction, and a scheduling for service of the battery or fleet of batteries. The cloud based aspect of the system 257 then transfers at least one of the battery health, the enterprise of acceptability, the battery state marker 340, the battery health prediction, and a scheduling for service of the battery or fleet of batteries to the mobile device or dashboard 245 for viewing by an operator. Such information may also be transferred through the communication module to the battery (55, 60) or fleet of batteries (235A, 235B, 235C) to provide for optimization of a performance of at least one battery module (55, 60*). Such a system 220 and method 350 provides for the digital service offerings 415 and battery service 417 which calculates among other things the health of the battery module (55, 60*) and/or battery fleet, and components of the vehicle 10 in which the battery resides, and provides for a service schedule, a calculation of the duration of time before replacement of the battery and/or fleet of batteries, and/or potential options for such replacement such as location and whether to purchase or exchange, etc.

As illustrated in FIGS. 8B, 10, 14, 15, 16, and 17B, an illustration of the method 350 as applied to the system 220 is further provided. In method steps 360 to 370, the battery system (15A, 15B, 15C, 15D), the battery module (55, 60*) as a smart battery, and/or the OBDII 335 receive the battery sensor data 315, the battery tester data 325, and/or the telematics and vehicle parameter data 330, with each incorporating at least one sensor 165A. At least one of the battery system (15A, 15B, 15C, 15D), the battery module (55, 60*) as a smart battery, and/or the OBDII 335 provides for calculations of the battery diagnostics 320 (including but not limited to SOC, SOH, and/or SOF of the battery) and other parameter data as previously described. Additionally, each of the at least one of the battery system (15A, 15B, 15C, 15D), the battery module (55, 60*) as a smart battery, and/or the OBDII 335 may fulfill the functions as a battery management system (BMS) for managing the respective battery or fleet of batteries. In doing so, computing on a component level is achieved for at least one battery diagnostic 320 is computed for a respective battery module (55, 60*) or grouping of batteries. Further, system level computing of battery diagnostics 320 are performed for at least one battery in a system, for example a vehicle 10. Finally, vehicle level computation of at least one of the vehicle diagnostics and the telematics data 330 is performed for the particular system, for example a vehicle 10. In doing so, the OBDII or equivalent technology 335 may provide for the above stated management for a grouping of batteries in which a particular battery module (55, 60*) is communicatively coupled and/or management of the vehicle 10 in which the battery module (55, 60*) resides or the vehicles components of such vehicle 10. In method step 375, such information from the battery module (55, 60*) and/or the OBDII or equivalent technology 335 maybe electrically transferred to the cloud based aspect of the system 257. In method steps 380-400, the cloud based aspect of the system 257 provides for artificial intelligence and machine learning integrated with internal programs of the cloud based aspect of the system 257 to provide for calculations of at least one of the battery health, the enterprise of acceptability, the battery state marker 340, the battery health prediction, and a scheduling for service of the battery or fleet of batteries. Notably, the calculation of the battery health may result calculation of the battery state marker 340. As stated, the system 220 may apply historical data as described in the calculations of battery health and the battery state marker 340. At least one mobile device and dashboard 245 may integrate communication between the battery or fleet of batteries and the cloud based aspect of the system 257 to provide for the digital service offerings 415 and battery service 417. The digital service offerings 415 and battery service 417 may provide for vehicle OEM software, automotive manufacture software, and/or automotive fleet software where a fleet is a grouping of cars applied for a similar purpose. Such software singularly or in combination provides for fleet energy management, BIP, and/or Battery-aaS.

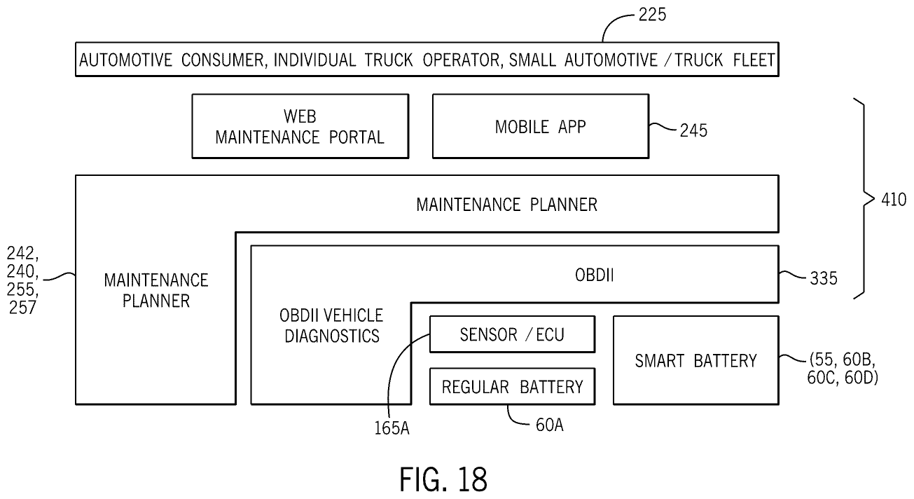

With reference to FIGS. 1-18, the combination of the system 15 and method 350 provides for an umbrella relationship of the previously described features of the system 15 and method 350. The smart battery (55, 60B, 60C, 60D), or battery 60A, with a sensor (165A, 165B, 165C, 195A, 195B) communicates data to the cloud based aspect of the system 257. This communication may be performed through an OBDII or equivalent technology 335. The smart battery (55, 60B, 60C, 60D), or battery 60A may be systematically and methodically in electrical communication with the vehicle diagnostics. The cloud based aspect of the system 257, with application of at least one server 240 and at least one database 242, calculates a maintenance planner for the battery module (55, 60*) or grouping of batteries pursuant to the battery data and OBDII or equivalent technology 335 data, which results in the battery state marker 340. This calculation may be performed applying historical battery data saved in the database and server for batteries of a same or similar type, same or similar size, same or similar model, and/or same or similar make. The maintenance plan is communicated through a mobile application and/or a web maintenance portal such that the automotive customer, truck operator, and/or fleet manager may manage the battery module (55, 60*) or grouping of batteries in order to determine when a battery should be replaced.

One or more of the disclosed embodiments, alone or in combination, may provide one or more technical effects including the controlled leasing of battery modules (e.g., prismatic battery cells). The technical effects and technical problems in the specification are exemplary and are not limiting. It should be noted that the embodiments described in the specification may have other technical effects and can solve other technical problems.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods. Examples of suitable processors or processing systems include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) can include at least one hardware circuit (e.g., an integrated circuit) configured to carry out instructions contained in program code. In arrangements in which there are a plurality of processors, such processors can work independently from each other or one or more processors can work in combination with each other.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

It is also important to note that the construction and arrangement of the system, methods, and devices as shown in the various examples of embodiments is illustrative only, and not limiting. Although only a few embodiments have been described in detail in this disclosure, those skilled in the art who review this disclosure will readily appreciate that many various alternatives, modifications, variations, improvements and/or substantial equivalents, whether known or that are or may be presently foreseen, are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. Other substitutions, modifications, changes, and omissions may be made in the design, operating conditions, and arrangement of the various examples of embodiments without departing from the spirit or scope of the present inventions. Therefore, the invention is intended to embrace all known or earlier developed alternatives, modifications, variations, improvements and/or substantial equivalents.

1. A battery replacement system based on a value for enterprise acceptability of a battery module, the system comprising:
the battery module comprising:
a sensor to sense a parameter of the battery module; and
a processor and memory operatively coupled to the sensor, the memory including instructions executable by the processor to maintain battery module information, store the sensed parameter, and communicate the battery module information and the sensed parameter;
a server in communication with the battery module for receipt of the battery module information and the sensed parameter; and
one of the battery module and the server having a calculation for a life estimation and a replacement determination for the battery module based on a value for enterprise acceptability.

2. The system of claim 1, the memory includes further instructions executable by the processor to receive the value for enterprise acceptability from the server, calculate the life estimation for the battery module, and compare the life estimation with the value for enterprise acceptability.

3. The system of claim 2, wherein the further instructions being based on conditional stresses imparted onto the battery module.

4. The system of claim 3, wherein the conditional stresses on the battery module comprise of humidity, temperature, location, elevation, and/or load variants.

5. The system of claim 1, wherein the value for enterprise acceptability is based on one or more of a safety characterization, an ease of replacement characterization, and a criticality characterization, for the battery module.

6. The system of claim 1, wherein the server comprises a database.

7. The system of claim 6, wherein the database comprises an historical battery data.

8. The system of claim 7, wherein the historical battery data comprises one or more parameters of one or more historical battery modules and one or more battery diagnostic of the one or more historical battery modules, where the one or more historical battery modules are substantially similar for one or more of battery type, battery size, battery make, and battery model, to the battery module.

9. The system of claim 6, wherein the server further comprises:
a communication module to receive the information from the battery module;
a processor and memory operatively coupled to the communication module, the memory including instructions executable by the processor to:
receive the information and collect data from the received information;
calculate the life estimation for the battery module based on the received information and the collected data;
determine a value for enterprise acceptability for the battery module;
compare the life estimation with the value for enterprise acceptability for the battery module; and
communicate a replacement determination based on the comparison.

10. A method for communicating replacement determinations for vehicle battery modules, the method comprising:
receiving information from a battery module;
calculating a life estimation for the battery module based upon the received information;
determining a value for enterprise acceptability for the battery module based upon the received information; and
communicating a replacement determination based on a comparison based upon of the life estimation and the value for enterprise acceptability.

11. The method of claim 10, wherein the battery module is one of a defined group of battery modules, and wherein the method further comprises:
receiving a second information from the defined group of battery modules; and
pooling data from the received second information from the defined group of battery modules, the pooled data functionally related to life estimations, and the calculating the life estimation for the battery module is further based on the pooled data.

12. The method of claim 10, further comprising collecting one or more of conditional stresses imparted onto the battery module from the received information, with the calculating the life estimation for the battery module further based on the collected one or more conditional stresses.

13. The method of claim 12, the method further comprising:
determining a rate of change for at least part of the collected one or more conditional stresses; and
revising the life estimation of the battery module based on the rate of change.

14. The method of claim 11, further comprising:
receiving a third information about a deconstructed battery module from the defined group of battery modules, with the calculating the life estimation for the battery module further based on a portion of the third information.

15. The method of claim 10, wherein the communicating the replacement determination occurs when the life estimation traverses the value for enterprise acceptability, thereby indicating an improperly functioning battery module, with the value for enterprise acceptability being based on one or more of a safety characterization, an ease of replacement characterization, and a criticality characterization, for the battery module.

16. A battery replacement system based upon a value for enterprise acceptability of a battery module, the system comprising:
a battery module comprising:
a housing;
one or more battery cells arranged within the housing;
a sensor to sense a parameter of the battery module; and
a processor and a memory operatively connected to the sensor, the memory including instructions executable by the processor to:
acquired data related to the sensed parameter;
retain battery module information; and
communicate the battery module information and at least a portion of the sensed data;
a server in communication with the battery module for receipt of the information; and
one of the battery module and the server calculates a life estimation for the battery module based on the information and makes a replacement determination based on comparing the life estimation with the value for enterprise acceptability.

17. The battery module of claim 16 wherein the value for enterprise acceptability is based on one or more of, for the battery module, a safety characterization, an ease of replacement characterization, and a criticality characterization.

18. The battery module of claim 16, wherein the server comprises:
a communication module to receive the information from the battery module;
a server processor; and
a server memory operatively connected to the processor, the server memory storing instructions that causes the server processor to:
receive the information;
collect data from the received information, the collected data functionally related to life estimations;
calculate a life estimation for the battery module based on the received information and the collected data;
determine a value for enterprise acceptability for the battery module;
compare the life estimation with the value for enterprise acceptability for the battery module; and
communicate a replacement determination based on the comparison.

19. A method for applying the battery replacement system of claim 16, the method comprising:
receiving the information from battery module;
collecting data from the received information, the collected data functionally related to end of life determinations;
calculating a life estimation for the battery module based on the received information and the collected data;
determining a value for enterprise acceptability for the battery module;
comparing the life estimation with the value for enterprise acceptability for the battery module; and
communicating a replacement determination based on the comparison.

20. The method of claim 19, wherein the battery module is one of a defined group of battery modules, and wherein the method further comprises:
receiving information from the defined group of battery modules; and
pooling data from the received information, the pooled data functionally related to life determinations;
collecting one or more conditional stresses imparted onto the defined group of battery modules; and
associating at least portions of the pooled data with the one or more conditional stresses imparted onto the defined group of battery modules.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)
